(19) United States
(12) Patent Application Publication
(10) Pub. No.: US 2025/0383208 A1
(43) Pub. Date: Dec. 18, 2025

(54) TIME ALIGNMENT OF GLOBAL POSITIONING SYSTEM (GPS) AND CAMERA SIGNALS

(71) Applicant: TOYOTA JIDOSHA KABUSHIKI KAISHA, TOYOTA-SHI (JP)

(72) Inventors: PAUL J. OZOG, Ann Arbor, MI (US); MOHAMED ALADEM, Ypsilanti, MI (US); MATTHEW WALKER DREISBACH, Ann Arbor, MI (US)

(21) Appl. No.: 18/745,878

(22) Filed: Jun. 17, 2024

(51) Int. Cl. G01C 21/28; G01C 21/36; G07C 5/02

(52) U.S. Cl. CPC G01C 21/28; G01C 21/3691; G07C 5/02

(57) ABSTRACT

Systems and methods are provided for synchronizing sensor data from a plurality of sensors of a vehicle. The systems and methods may receive a first data relating to an event from a first sensor of a vehicle. The first data may include a first time stamp. The systems and methods may receive a second data relating to the event from a second sensor of the vehicle. The second data may include a second time stamp. The systems and methods may determine the first time stamp is not identical to the second time stamp. The systems and methods may determine which of the first time stamp and the second time stamp is a correct time stamp for the event. The systems and methods may synchronize the first and second data according to the correct time stamp and an area under the curve (AUC) difference between the first and second data.

### TECHNICAL FIELD

The present disclosure relates generally to the field of vehicular sensors, and in particular, some implementations may relate to systems and methods for synchronizing sensor data of a vehicle.

### DESCRIPTION OF RELATED ART

Vehicles may be used as a means of transportation for the public. Vehicles may include automobiles, trucks, motorcycles, bicycles, scooters, mopeds, recreational vehicles and other like on- or off-road vehicles. Vehicles may further include autonomous, semi-autonomous and manual vehicles. As useful as vehicles are for transportation, vehicles may also be useful in the collection of data associated to one or more events relating to and consisting of one or more objects, subjects, and/or features that are encountered by a vehicle during its travel. An object and/or subject may include a vehicle, pedestrian, building, obstacle, road, traffic sign, light pole, landmark, and other objects and subjects that a vehicle may encounter while traveling. A feature may include the speed of a vehicle, steering of a vehicle, tire traction of a vehicle, position of an obstacle, structure of a building, shape of a landmark, weather at a location, traffic on a road, and other features of objects and subjects that a vehicle may encounter while traveling.

With vehicles consistently traveling on roads at all times of the day and year, it may be important for data collected and received by vehicles during their travels to be synchronized to ensure such data is properly and accurately collected, analyzed, and recorded regarding events relating to and consisting of one or more objects, subjects, and/or features that are encountered by such vehicles. With most present vehicles traveling on roads including one or more sensors that may be used to collect data of various events relating to and consisting of one or more objects, subjects, and features, both internal and external to the respective vehicle, data collected by vehicles may be used to accurately and efficiently relay information associated to the events relating to and consisting of one or more objects, subjects, and/or features identified and detected by a vehicle. Currently, such information and data collected by vehicles may not be synchronized accurately with respect to events relating to and consisting of one or more objects, subjects, and/or features encountered by such vehicles, that may lead to other resources to be used to evaluate and determine the accuracy of such data, which can be costly.

### BRIEF SUMMARY OF THE DISCLOSURE

According to various embodiments of the disclosed technology, systems and methods for synchronizing sensor data are provided. In various implementations, the disclosed technology may be used to determine a correct time-stamp of the sensor data, which may be used to determine and provide a more accurate information gleaned from the sensor data. For example, a correct time stamp may provide a more accurate location of a landmark detected using the sensor data. Thus, some applications may improve the accuracy with which landmarks in the external environment of the vehicle (e.g., traffic lights, stop signs, road signs, etc.) are identified and located. This information may be used in some applications to improve the functioning of sensor data processing systems in applications such as detecting landmarks in the environment of the vehicle. This improvement in the accuracy of sensor data, and identifying and locating landmarks, may be used to update a map of the environment where the updated map may be used to navigate a vehicle more efficiently through the environment.

In accordance with some implementations, a method for synchronizing sensor data from a plurality of sensors of a vehicle is provided. The method may include: receiving, from a first sensor, a first data relating to an event, wherein the first data includes a first time stamp; receiving, from a second sensor, a second data relating to the event, wherein the second data includes a second time stamp; determining the first time stamp is not identical to the second time stamp; determining which of the first time stamp and the second time stamp is a correct time stamp for the event; and synchronizing, based on the correct time stamp, the first data and the second data.

In some applications, the determining the first time stamp is not identical to the second time stamp includes: comparing the first time stamp to a first local clock of the first sensor; comparing the second time stamp to a second local clock of the second sensor; determining a time delay between at least the first time stamp and the first local clock or the second time stamp and the second local clock; and determining the first time stamp is not identical to the second time stamp according to the time delay.

In some applications, the synchronizing, based on the correct time stamp, the first data and the second data includes adjusting at least one of the first data and the second data according to the correct time stamp and an area under the curve (AUC) difference between the first data and the second data.

In some applications, the AUC difference includes: determining a first AUC of the first data; determining a second AUC of the second data; and determining the AUC difference between the first AUC and the second AUC.

In some applications, the first sensor is located at a first location on the vehicle and the second sensor is located at a second location on the vehicle.

In some applications, the first and second sensors each include at least one of a camera, image sensor, radar sensor, environmental sensor, light detection and ranging (LiDAR) sensor, electromyography sensor, motion sensor, pressure sensor, position sensor, audio sensor, infrared sensor, microwave sensor, optical sensor, haptic sensor, magnetometer, communication system and global positioning system (GPS).

In some applications, the first data and the second data each include at least one of environmental data and vehicular data.

In some applications, the environmental data includes a road condition, traffic, location, coordinates, population, landscape, landmark, terrain, territory, weather, temperature, humidity, pollution, habitat, and other environmental surroundings.

In some applications, the vehicular data includes a speed, acceleration, direction, handling, torque, trajectory, force, tire grip, traction, and steering of the vehicle.

In some applications, the correct time stamp is a time that the event is first detected by either the first sensor or the second sensor.

In some applications, the event is a detection of an element in an environment of the vehicle, and the method may further include using the correct time stamp to determine a location of the detected element.

In another aspect, a system for synchronizing sensor data from a plurality of sensors of a vehicle is provided that may include one or more processors; and memory coupled to the one or more processors to store instructions, which when executed by the one or more processors, may cause the one or more processors to perform operations. The operations may include: receiving, from a first sensor, a first data relating to an event, wherein the first data includes a first time stamp; receiving, from a second sensor, a second data relating to the event, wherein the second data includes a second time stamp; determining the first time stamp is not identical to the second time stamp; determining which of the first time stamp and the second time stamp is a correct time stamp for the event; and synchronizing, based on the correct time stamp, the first data and the second data.

In some applications, the determining the first time stamp is not identical to the second time stamp includes: comparing the first time stamp to a first local clock of the first sensor; comparing the second time stamp to a second local clock of the second sensor; determining a time delay between at least the first time stamp and the first local clock or the second time stamp and the second local clock; and determining the first time stamp is not identical to the second time stamp according to the time delay.

In some applications, the synchronizing, based on the correct time stamp, the first data and the second data includes adjusting at least one of the first data and the second data according to the correct time stamp and an area under the curve (AUC) difference between the first data and the second data.

In some applications, the AUC difference includes: determining a first AUC of the first data; determining a second AUC of the second data; and determining the AUC difference between the first AUC and the second AUC.

In some applications, the first sensor is located at a first location on the vehicle and the second sensor is located at a second location on the vehicle.

In some applications, the first and second sensors each include at least one of a camera, image sensor, radar sensor, environmental sensor, light detection and ranging (LiDAR) sensor, electromyography sensor, motion sensor, pressure sensor, position sensor, audio sensor, infrared sensor, microwave sensor, optical sensor, haptic sensor, magnetometer, communication system and global positioning system (GPS).

In some applications, the first data and the second data each include at least one of environmental data and vehicular data.

In some applications, the environmental data includes a road condition, traffic, location, coordinates, population, landscape, landmark, terrain, territory, weather, temperature, humidity, pollution, habitat, and other environmental surroundings.

In some applications, the vehicular data includes a speed, acceleration, direction, handling, torque, trajectory, force, tire grip, traction, and steering of the vehicle.

In some applications, the correct time stamp is a time that the event is first detected by either the first sensor or the second sensor.

In some applications, the event is a detection of an element in an environment of the vehicle, and the operations may further include using the correct time stamp to determine a location of the detected element.

In another aspect, a non-transitory machine-readable medium is provided. The non-transitory computer-readable medium may include instructions that when executed by a processor may cause the processor to perform operations including: receiving, from a first sensor, a first data relating to an event, wherein the first data includes a first time stamp; receiving, from a second sensor, a second data relating to the event, wherein the second data includes a second time stamp; determining the first time stamp is not identical to the second time stamp; determining which of the first time stamp and the second time stamp is a correct time stamp for the event; and synchronizing, based on the correct time stamp, the first data and the second data.

In some applications, the determining the first time stamp is not identical to the second time stamp includes: comparing the first time stamp to a first local clock of the first sensor; comparing the second time stamp to a second local clock of the second sensor; determining a time delay between at least the first time stamp and the first local clock or the second time stamp and the second local clock; and determining the first time stamp is not identical to the second time stamp according to the time delay.

In some applications, the synchronizing, based on the correct time stamp, the first data and the second data includes adjusting at least one of the first data and the second data according to the correct time stamp and an area under the curve (AUC) difference between the first data and the second data.

In some applications, the AUC difference includes: determining a first AUC of the first data; determining a second AUC of the second data; and determining the AUC difference between the first AUC and the second AUC.

In some applications, the first sensor is located at a first location on the vehicle and the second sensor is located at a second location on the vehicle.

In some applications, the first and second sensors each include at least one of a camera, image sensor, radar sensor, environmental sensor, light detection and ranging (LiDAR) sensor, electromyography sensor, motion sensor, pressure sensor, position sensor, audio sensor, infrared sensor, microwave sensor, optical sensor, haptic sensor, magnetometer, communication system and global positioning system (GPS).

In some applications, the first data and the second data each include at least one of environmental data and vehicular data.

In some applications, the environmental data includes a road condition, traffic, location, coordinates, population, landscape, landmark, terrain, territory, weather, temperature, humidity, pollution, habitat, and other environmental surroundings.

In some applications, the vehicular data includes a speed, acceleration, direction, handling, torque, trajectory, force, tire grip, traction, and steering of the vehicle.

In some applications, the correct time stamp is a time that the event is first detected by either the first sensor or the second sensor.

In some applications, the event is a detection of an element in an environment of the vehicle, and the operations may further include using the correct time stamp to determine a location of the detected element.

Other features and aspects of the disclosed technology will become apparent from the following detailed description, taken in conjunction with the accompanying drawings, which illustrate, by way of example, the features in accordance with embodiments of the disclosed technology. The summary is not intended to limit the scope of any inventions described herein, which are defined solely by the claims attached hereto.

### BRIEF DESCRIPTION OF THE DRAWINGS

The present disclosure, in accordance with one or more various embodiments, is described in detail with reference to the following figures. The figures are provided for purposes of illustration only and merely depict typical or example embodiments.

FIG. 1 illustrates an example computing system for synchronizing sensor data with which embodiments of the systems and methods disclosed herein may be implemented.

FIG. 2 illustrates an example vehicle with which embodiments of the systems and methods disclosed herein may be implemented.

FIG. 3 illustrates an example system for synchronizing sensor data in accordance with one embodiment of the systems and methods described herein.

FIG. 4 illustrates an example system for synchronizing sensor data in accordance with one embodiment of the systems and methods described herein.

FIG. 5 illustrates example sensor data to be synchronized in accordance with one embodiment of the systems and methods described herein.

FIG. 6 illustrates an example computing component that includes one or more hardware processors and machine-readable storage media storing a set of machine-readable/machine-executable instructions that, when executed, cause the one or more hardware processors to perform an illustrative method for synchronizing sensor data in accordance with one embodiment of the systems and methods described herein.

FIG. 7 illustrates an example computing component that may be used to implement various features of embodiments described in the present disclosure.

The figures are not exhaustive and do not limit the present disclosure to the precise form disclosed.

### DETAILED DESCRIPTION

As described above, vehicles may be used as a means of transportation for the public. Vehicles may include, for example, automobiles, trucks, motorcycles, bicycles, scooters, mopeds, recreational vehicles and other like on- or off-road vehicles. Vehicles may include, for example, an autonomous, semi-autonomous and manual operation vehicles. While traveling on a path, an ego vehicle may collect and receive data associated with one or more events relating to and consisting of one or more objects, subjects, and features that the ego vehicle encounters.

Aspects of the technology disclosed herein may provide systems and methods configured to synchronize data sets collected and received by an ego vehicle while the ego vehicle is traveling. A data synchronization system may use sensors and algorithms, such as machine learning (ML) algorithms and models, to accurately synchronize data sets collected and received by the ego vehicle. The data sets collected and received may be associated with one or more events relating to and consisting of one or more objects, subjects, and/or features that the ego vehicle encounters while traveling. The data sets collected and received may include, for example, environmental data, vehicular data, and driver data. The environmental data may include, for example data relating to, a road condition, traffic, location, landmarks, coordinates, population, landscape, terrain, territory, weather, temperature, humidity, pollution, habitat, and other environmental surroundings around the ego vehicle. The vehicular data may include a speed, acceleration, direction, handling, torque, trajectory, force, tire grip, traction, and steering of the ego vehicle. The driver data may include driver identification, driver performance characteristics, and driver setting preference.

Due to various factors, timestamps associated with data from various sensors may vary from sensor to sensor. Thus, systems using that data for various purposes (e.g., vehicle navigation, map creation and updating, environmental detection, etc.) may make inaccurate or ambiguous determinations due to this variation. In various implementations, synchronization may be used to determine a correct time stamp of the sensor data, which may be used to determine and provide more accurate information gleaned from the sensor data. For example, a correct time stamp may provide a more accurate location of a landmark detected and identified using the sensor data. Thus, some applications may improve the accuracy with which landmarks in the external environment of the vehicle (e.g., traffic lights, stop signs, road signs, etc.) are identified and located. This information may be used in some applications to improve the functioning of sensor data processing systems in applications such as, for example, vehicle tracking and detecting landmarks in the environment of the vehicle. This improvement in the accuracy of sensor data, and identifying and locating landmarks, may be used to update a map of the environment where the updated map may be used to navigate a vehicle more efficiently through the environment.

The data synchronization system may collect and receive data from one or more sensors, including a first sensor and a second sensor. The one or more sensors may be located on the ego vehicle. The one or more sensors may be located outside the ego vehicle and the ego vehicle may be able to communicate to the one or more sensors to receive data. The one or more sensors may be located at different locations on and off the ego vehicle. The one or more sensors may include at least one of a camera, image sensor, radar sensor, environmental sensor, light detection and ranging (LiDAR) sensor, electromyography sensor, motion sensor, pressure sensor, position sensor, audio sensor, infrared sensor, microwave sensor, optical sensor, haptic sensor, magnetometer, communication system and global positioning system (GPS).

The data synchronization system may receive first data from a first sensor. The first sensor may be located on the ego vehicle at a first position. The first data may include environmental data, vehicular data, and driver data. The first data of the first sensor may include a first time stamp, with the first time stamp indicating the time the first data was collected and received.

The data synchronization system may receive second data from a second sensor. The second sensor may be located on the ego vehicle at a second position. The second position of the second sensor may be different from the first position of the first sensor. The second data may include environmental data, vehicular data, and driver data. The second data of the second sensor may include a second time stamp, with the second time stamp indicating the time the second data was collected and received.

The data synchronization system may collect and receive data from one or more sensors, including the first sensor and the second sensor. Each sensor may collect and provide an individual set of data that is different from the data collected and provided by other sensors. Each sensor's data may be associated to at least one event relating to and consisting of one or more objects and/or subjects, including, for example, the ego vehicle, another surrounding vehicle, a pedestrian, building, obstacle, road, traffic sign, light pole, landmark, and other objects and subjects that the ego vehicle may encounter while traveling. Each sensor's data may be associated to at least one feature, including, for example, the speed of the ego vehicle, steering of the ego vehicle, tire traction of the ego vehicle, speed of another surrounding vehicle, position of an obstacle, structure of a building, shape of a landmark, weather at a location, traffic on a road, and other features of objects and subjects that the ego vehicle may encounter while traveling. The event may be a detection of an element in an environment, such as, for example, an object, subject, and/or feature, of the vehicle.

More than one sensor, including the first sensor and the second sensor, may have their own respective data, including the first data of the first sensor and the second data of the second sensor, that may be associated to the same event. The event may be related and consist of one or more of the same objects, subjects, and/or features. The event may be a detection of an element in an environment, such as, for example, an object, subject, and/or feature, of the vehicle. The data synchronization system may determine whether the first data of the first sensor and the second data of the second sensor are associated to the same event. The data synchronization system may analyze the first data and the second data to determine if they are related to and directed towards the same event relating to and consisting of the same one or more objects, subjects, and/or features.

The first data of the first sensor may include a first time stamp, with the first time stamp indicating the time the first data was collected and received. The second data of the second sensor may include a second time stamp, with the second time stamp indicating the time the second data was collected and received. Upon a determination that the first data and the second data are associated to the same event relating to and consisting of one or more objects, subjects, and/or features, the data synchronization system may determine the first time stamp of the first data and the second time stamp of the second data. The data synchronization system may compare the first time stamp of the first data to the second time stamp of the second data to determine whether the first time stamp is identical to the second time stamp.

To determine whether the first time stamp is identical to the second time stamp, the data synchronization system may first compare the first time stamp to a first local clock of the first sensor. The data synchronization system may also compare the second time stamp to a second local clock of the second sensor. The data synchronization system may determine if there is a time delay between at least the first time stamp and the first local clock or the second time stamp and the second local clock. The data synchronization system may determine the first time stamp is not identical to the second time stamp according to the determined time delay.

Upon a determination that the first time stamp of the first data is not identical to the second time stamp of the second data, the data synchronization system may determine which of the first time stamp and the second time stamp is the correct time stamp for the event. The correct time stamp is a time that the event relating to and consisting of one or more objects, subjects, and/or features of the first data and the second data is first identified and detected by either the first sensor or the second sensor. The correct time stamp may be used to determine an accurate location of an object and/or subject of an event in the environment.

Upon a determination of the correct time stamp between the first time stamp and the second time stamp, the data synchronization system may synchronize the first data and the second data according to the correct time stamp. The data synchronization system may synchronize the first data and the second data by adjusting at least one of the first data and the second data according to the correct time stamp and an area under the curve (AUC) difference between the first data and the second data. The AUC of a data set, such as the first data or second data, may be the area bounded by a curve, axis, and boundary points of a data set.

Each data set may be graphed by the data synchronization system to determine the curve, axis, and boundary points to be used to determine the AUC of the respective data set. To determine the AUC difference between the first data and the second data, the data synchronization system may graph the first data and the second data. The data synchronization system may analyze the graph of the first data to determine a curve, axis, and boundary points of the first data. The data synchronization system may use the curve, axis, and boundary points of the first data to determine the first AUC of the first data. The data synchronization system may analyze the graph of the second data to determine a curve, axis, and boundary points of the second data. The data synchronization system may use the curve, axis, and boundary points of the second data to determine the second AUC of the second data. The data synchronization system may analyze the first AUC against the second AUC to determine the AUC difference between the first data and the second data. The AUC difference may include one or more absolute values of the difference between the first AUC of the first data and the second AUC of the second data.

The data synchronization system may determine the AUC difference between the first data and the second data over a time series. The time series can be the full length of time that the first data and the second data are both associated with the same event relating to and consisting of one or more objects, subjects, and/or features. The time series may be a preset length of time in determining the AUC of a data set. The time series may be inputted by an entity, such as, for example, a driver of the ego vehicle, an admin of the data synchronization system, a law enforcement agency, a security agency, etc. Using the AUC difference and the correct time stamp, the data synchronization system may synchronize the first data and the second data by using the AUC difference to correlate the curves of the first data and the second data over the time series. The data synchronization system may determine the smallest value of the one or more absolute values of the AUC difference. The data synchronization system may synchronize the first data and the second data by using the smallest absolute value of the AUC difference to shift at least one of the first data and the second data for the time series.

The data synchronization system may use the AUC difference of the first data and the second data to train a machine learning (ML) model. The ML model may use one or more ML algorithms to evaluate data and synchronize data sets that are associated with the same event relating to and consisting of one or more objects, subjects, and/or features. Synchronizing data sets, including, for example, the first data and the second data, that are associated with the same event relating to and consisting of one or more objects, subjects, and/or features for a period of time may increase the accuracy in the collection, analysis, determination, and recordation of data associated with events, objects, subjects, and/or features. The synchronized data sets may also be used to correct any time delays or lags between the local clocks of sensors, which may also increase the accuracy in the collection, analysis, determination, and recordation of data associated with events, objects, subjects, and/or features. Such accurate data with accurate time stamps may be used to accurately identify and detect particular objects, subjects, and/or features of events in an environment at the precise time and location that such objects, subjects, and/or features of such events were identified and detected by an ego vehicle. Entities, such as, for example, the driver of the ego vehicle, law enforcement, security agency, mechanics, paramedics, emergency responders, tow trucks, news agency, etc., may be able to use the synchronized data to more efficiently and effectively relay and respond to the events, objects, subjects, and/or features identified and detected by the ego vehicle. The accurate data, along with the precise time and location of events, objects, subjects, and/or features, may be used to update a map of the environment where the updated map may be used to navigate a vehicle more efficiently through the environment. Many variations are possible.

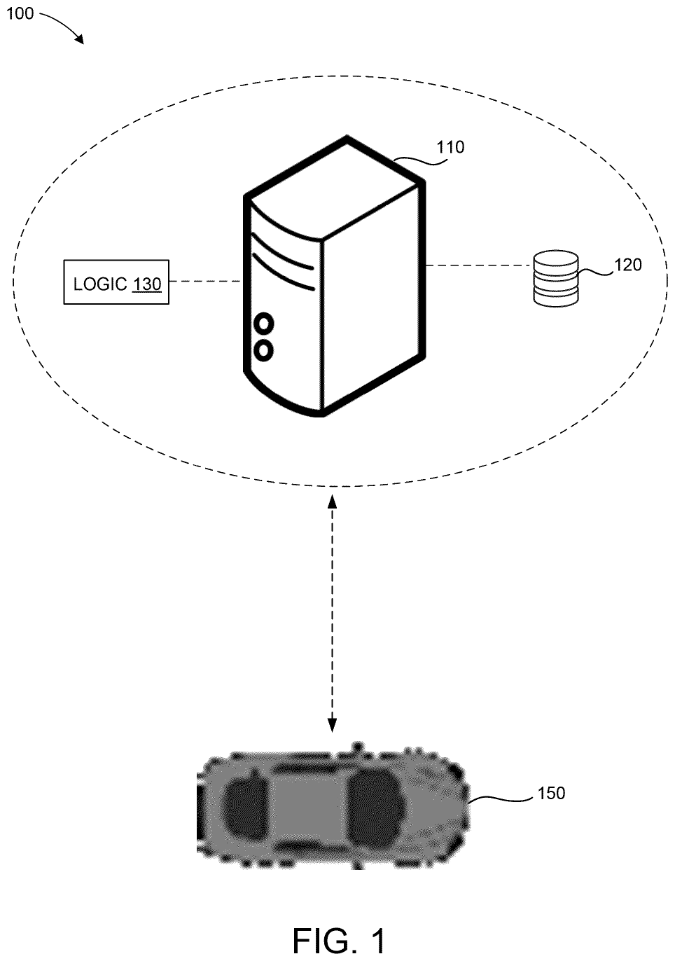

FIG. 1 illustrates an example of a computing system 100 which may be internal or otherwise associated within a vehicle 150. In some embodiments, the computing system 100 may be a machine learning (ML) pipeline and model, and use ML algorithms. In some examples, the vehicle 150 may be a vehicle, such as an automobile, truck, motorcycle, bicycle, scooter, moped, recreational vehicle and other like on- or off-road vehicles. The vehicle 150 may input data into computing component 110. The computing component 110 may perform one or more available operations on the input data to generate outputs, such as receive one or more sensor data from one or more sensors, determine a first sensor data and a second sensor data of the one or more sensor data are associated with a particular event relating to and consisting of one or more objects and/or subjects, determine the first sensor data and the second sensor data have unidentical time stamps, determine which of the time stamps of the first sensor data and the second sensor data is a correct time stamp for the particular event, and synchronize the first sensor data and the second sensor data based on the correct time stamp. The one or more sensors may be located on and/or in the vehicle 150. The vehicle 150 may further display the outputs on a Graphical User Interface (GUI). The GUI may be in vehicle 150 or on a computing device, such as a desktop computer, a laptop, a mobile phone, a tablet device, an Internet of Things (IoT) device, etc. The GUI may display the outputs as a two-dimensional (2D) and three-dimensional (3D) layout and map showing the various outputs generated by algorithms, such as ML algorithms, based on various input data, such as parking data including the time, location, and parking duration from vehicle 150.

The computing system 110 in the illustrated example may include one or more processors and logic 130 that implements instructions to carry out the functions of the computing component 110, for example, receiving one or more sensor data from one or more sensors, determining a first sensor data and a second sensor data of the one or more sensor data are associated with a particular event relating to and consisting of one or more objects and/or subjects, determining the first sensor data and the second sensor data have unidentical time stamps, determining which of the time stamps of the first sensor data and the second sensor data is a correct time stamp, and synchronizing the first sensor data and the second sensor data based on the correct time stamp. The computing component 110 may store, in a database 120, details regarding scenarios or conditions in which some algorithms, image datasets, and assessments are performed and used to collect and receive sensor data, determine at least two sensor data are associated with a particular event relating to and consisting of one or more objects and/or subjects, determine discrepancies in time stamps of the respective at least two sensor data, determine a correct time stamp from the respective time stamps of the at least two sensor data, and synchronize the at least two sensor data based on the correct time stamp. Some of the scenarios or conditions will be illustrated in the subsequent figures.

A processor may include one or more GPUs, CPUs, microprocessors or any other suitable processing system. Each of the one or more processors may include one or more single core or multicore processors. The one or more processors may execute instructions stored in a non-transitory computer readable medium. Logic 130 may contain instructions (e.g., program logic) executable by the one or more processors to execute various functions of computing component 110. Logic 130 may contain additional instructions as well, including instructions to transmit data to, receive data from, and interact with vehicle 150.

ML can refer to methods that, through the use of algorithms, are able to automatically extract intelligence or rules from training data sets and capture the same in informative models. In turn, those models are capable of making predictions based on patterns or inferences gleaned from subsequent data input into a trained model. According to implementations of the disclosed technology, the ML algorithm comprises, among other aspects, algorithms implementing a Gaussian process and the like. The ML algorithms disclosed herein may be supervised and/or unsupervised depending on the implementation. The ML algorithms may emulate the observed characteristics and components of vehicles, road, and drivers to better evaluate the environment around an ego vehicle to collect and receive sensor data, analyze a plurality of sensor data to determine at least two sensor data are associated with a particular event relating to and consisting of one or more objects and/or subjects, analyze the at least two sensor data to determine their respective time stamps are unidentical, determine a correct time stamp from the respective time stamps of the at least two sensor data, and synchronize the at least two sensor data based on the correct time stamp to improve the association and analysis of data collected by the ego vehicle.

Although one example computing system 110 is illustrated in FIG. 1, in various embodiments multiple computing systems 110 can be included. Additionally, one or more systems and subsystems of computing system 100 can include its own dedicated or shared computing component 110, or a variant thereof. Accordingly, although computing system 100 is illustrated as a discrete computing system, this is for ease of illustration only, and computing system 100 can be distributed among various systems or components.

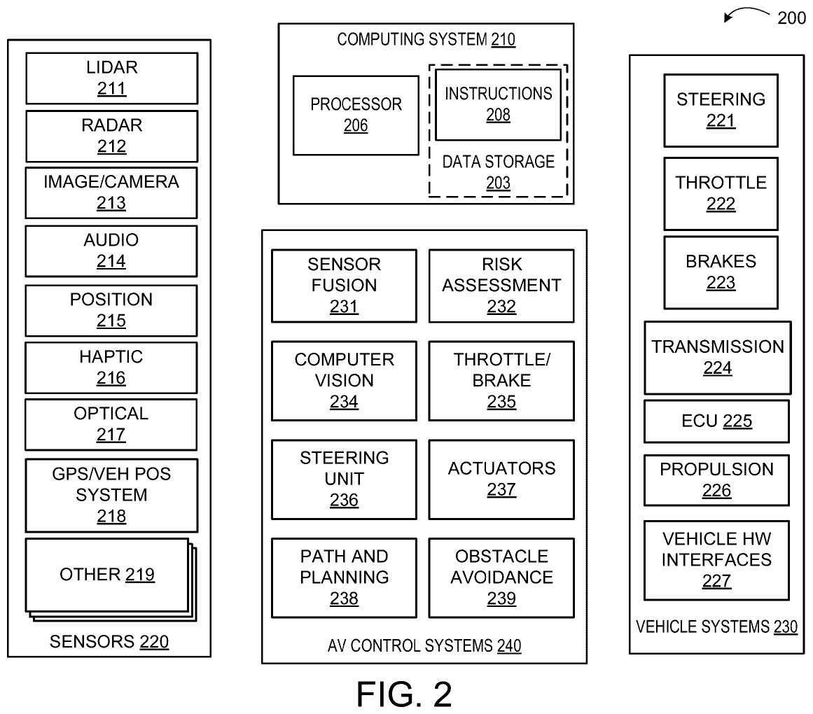

FIG. 2 is a schematic representation of various components or elements of an example connected vehicle 200, such as an autonomous, semi-autonomous or manual vehicle, with which applications of the disclosed technology may be implemented. As described herein, vehicle 200 can refer to a vehicle, such as an automobile, truck, motorcycle, bicycle, scooter, moped, recreational vehicle and other like on- or off-road vehicles, that may include an autonomous, semi-autonomous and manual operation. The vehicle 200 may include components, such as a computing system 210, sensors 220, AV control systems 240 and vehicle systems 230. Either of the computing system 210, sensors 220, AV control systems 240, and vehicle systems 230 can be part of an automated vehicle system/advanced driver assistance system (ADAS). ADAS can provide navigation control signals (i.e., control signals to actuate the vehicle and operate one or more vehicle systems 230 as shown in FIG. 2) for the vehicle to navigate a variety of situations. As used herein, ADAS can be an autonomous vehicle control system adapted for any level of vehicle control and driving autonomy. For example, the ADAS can be adapted for level 1, level 2, level 3, level 4, and level 5 autonomy (according to SAE standard). ADAS can allow for control mode blending (i.e., blending of autonomous and assisted control modes with human driver control). ADAS can correspond to a real-time machine perception system for vehicle actuation in a multi-vehicle environment. Vehicle 200 may include a greater or fewer quantity of systems and subsystems, and each could include multiple elements. Accordingly, one or more of the functions of the technology disclosed herein may be divided into additional functional or physical components, or combined into fewer functional or physical components. Additionally, although the systems and subsystems illustrated in FIG. 2 are shown as being partitioned in a particular way, the functions of vehicle 200 can be partitioned in other ways. For example, various vehicle systems and subsystems can be combined in different ways to share functionality.

Sensors 220 may include a plurality of different sensors to gather data regarding vehicle 200, its operator, its operation and its surrounding environment. Although various sensors are shown, it can be understood that systems and methods for collecting, receiving, and synchronizing data may not require many sensors. It can also be understood that system and methods described herein can be augmented by sensors off the vehicle 200. In this example, sensors 220 include light detection and ranging (LiDAR) sensor 211, radar sensor 212, image sensors 213 (e.g., a camera), audio sensors 214, position sensor 215, haptic sensor 216, optical sensor 217, a Global Positioning System (GPS) or other vehicle positioning system 218, and other like distance measurement, environment sensing, and vehicular monitoring sensors 219. Sensors 220 may include electromyography sensor, motion sensor, pressure sensor, infrared sensor, microwave sensor, magnetometer, and communication system. Sensors 220 may further include security sensors to monitory the security of the vehicle 200 when the vehicle is parked and stationary. One or more of the sensors 220 may gather data, such as environmental data and vehicular data. Environmental data may include, for example data relating to, road conditions, traffic, location, coordinates, population, landscapes, landmarks, terrain, territory, weather, temperature, humidity, pollution, habitat, and other environmental surroundings around an ego vehicle. Vehicular data may speed, acceleration, direction, handling, torque, trajectory, force, tire grip, traction, and steering of an ego vehicle. The one or more of the sensors 220 may send data to the vehicle electronic control unit (ECU) or other processing unit. Sensors 220 (and other vehicle components) may be duplicated for redundancy.

Distance measuring sensors such as LiDAR sensor 211, radar sensor 212, IR sensors and other like sensors can be used to gather data to measure distances and closing rates to various external objects such as other vehicles, roads, traffic signs, pedestrians, light poles and other objects. Image sensors 213 can include one or more cameras or other image sensors to capture images of the environment around the vehicle, such as weather and road surfaces, as well as internal to the vehicle. Information from image sensors 213 (e.g., camera) can be used to determine information about the environment surrounding the vehicle 200 including, for example, information regarding weather, road surfaces and other objects surrounding vehicle 200. For example, image sensors 213 may be able to recognize specific vehicles (e.g., color, vehicle type), landmarks or other features (including, e.g., street signs, traffic lights, etc.), slope of the road, lines on the road, damages and other potentially hazardous conditions to the road, curbs, objects to be avoided (e.g., other vehicles, pedestrians, bicyclists, etc.) and other landmarks or features. Information from image sensors 213 can be used in conjunction with other information such as map data, or information from positioning system 218 to determine, refine, or verify vehicle (ego vehicle or another vehicle) location as well as detect obstructions.

Vehicle positioning system 218 (e.g., GPS or other positioning system) can be used to gather position information about a current location of the vehicle as well as other positioning or navigation information, such as the positioning information about a current location and direction of movement of the vehicle according to a particular road.

Other sensors 219 may be provided as well. Other sensors 219 can include vehicle acceleration sensors, vehicle speed sensors, wheelspin sensors (i.e., one for each wheel), tire pressure monitoring sensors (i.e., one for each tire), vehicle clearance sensors, left-right and front-rear slip ratio sensors, environmental sensors (i.e., to detect weather, traction conditions, or other environmental conditions), seat pressure monitoring sensors (i.e., in the driver seat to measure muscle tension of the driver), motion sensors, electromyography sensors, and microwave sensors. Other sensors 219 can be further included for a given implementation of ADAS. Various sensors 220, such as other sensors 219, may be used to provide input to computing system 210 and other systems of vehicle 200 so that the systems have information useful to determine a crime probability and battery usage of the vehicle 200 for a particular parking location and generate a security plan for the vehicle 200 for the particular parking location.

AV control systems 240 may include a plurality of different systems/subsystems to control operation of vehicle 200. In this example, AV control systems 240 can include, autonomous driving module (not shown), sensor fusion module 231, risk assessment module 232, computer vision module 234, throttle and brake control unit 235, steering unit 236, actuator(s) 237, path and planning module 238, and obstacle avoidance module 239. Sensor fusion module 231 can be included to evaluate data from a plurality of sensors, including sensors 220. Sensor fusion module 231 may use computing system 210 or its own computing system to execute algorithms to assess inputs from the various sensors.

Throttle and brake control unit 235 can be used to control actuation of throttle and braking mechanisms of the vehicle to accelerate, slow down, stop or otherwise adjust the speed of the vehicle. For example, the throttle unit can control the operating speed of the engine or motor used to provide motive power for the vehicle. Likewise, the brake unit can be used to actuate brakes (e.g., disk, drum, etc.) or engage regenerative braking (i.e., such as in a hybrid or electric vehicle) to slow or stop the vehicle.

Steering unit 236 may include any of a number of different mechanisms to control or alter the heading of the vehicle. For example, steering unit 236 may include the appropriate control mechanisms to adjust the orientation of the front or rear wheels of the vehicle to accomplish changes in direction of the vehicle during operation. Electronic, hydraulic, mechanical or other steering mechanisms may be controlled by steering unit 236.

Computer vision module 234 may be included to process image data (e.g., image data captured from image sensors 213, or other image data) to evaluate the environment within or surrounding the vehicle. For example, algorithms operating as part of computer vision module 234 can evaluate still or moving images to determine features and landmarks (e.g., road pavements, lines of the road, damages and other potentially hazardous conditions on the road, road signs, traffic lights, lane markings and other road boundaries, etc.), obstacles (e.g., pedestrians, bicyclists, other vehicles, other obstructions in the path of the subject vehicle) and other objects. The system can include video tracking and other algorithms to recognize objects such as the foregoing, estimate their speed, map the surroundings, and so on. Computer vision module 234 may be able to model the road traffic vehicle network, predict incoming hazards and obstacles, predict road hazard, and determine one or more contributing factors to identifying and detecting obstructions. Computer vision module 234 may be able to perform depth estimation, image/video segmentation, camera localization, and object classification according to various classification techniques (including by applied neural networks).

Path and planning module 238 may be included to compute a desired path for vehicle 200 based on input from various other sensors and systems. For example, path and planning module 238 can use information from positioning system 218, sensor fusion module 231, computer vision module 234, obstacle avoidance module 239 (described below) and other systems (e.g., AV control systems 240, sensors 220, and vehicle systems 230) to determine a safe path to navigate the vehicle along a segment of a desired route. Path and planning module 238 may also be configured to dynamically update the vehicle path as real-time information is received from sensors 220 and other control systems 240.

Obstacle avoidance module 239 can be included to determine control inputs necessary to avoid obstacles and obstructions detected by sensors 220 or AV control systems 240. Obstacle avoidance module 239 can work in conjunction with path and planning module 238 to determine an appropriate path to avoid and navigate around obstacles and obstructions.

Path and planning module 238 (either alone or in conjunction with one or more other module of AV control systems 240, such as obstacle avoidance module 239, computer vision module 234, and sensor fusion module 231) may also be configured to perform and coordinate one or more vehicle maneuvers. Example vehicle maneuvers can include at least one of a path tracking, stabilization and collision avoidance maneuver. With connected vehicles, vehicle maneuvers can be performed at least partially cooperatively between the connected vehicles to gather a sufficient amount of data of the environment, including obstructions and traffic. A sufficient amount of data of an obstruction may include collecting data of the obstruction at various angles and perspectives. Each different type of obstruction may warrant a different amount of data to be collected and analyzed to make the needed determinations to verify the obstruction and determine the condition of traffic. For example, data needed to verify a small obstruction, like a small pothole, may be minimal as the connected vehicles collecting verification data of the small pothole obstruction may only need to collect data of missing asphalt on the road. The data needed to verify a larger obstruction, like a downed traffic light, may be much more extensive as the connected vehicles collecting verification data of the downed traffic light obstruction may need to collect data of the portion of the roadway blocked by the downed traffic light, electrical issues present on the roadway, disrupted traffic flow caused by the downed traffic light, including, for example, any other vehicles or objects blocking traffic due to the downed traffic light, additional obstructions on the road caused by the downed traffic light, including, for example, cracks, potholes, debris, etc., and so on. Hence, those of ordinary skill in the art will understand what sufficient means in the context of collecting a sufficient amount of data to verify an obstruction to determine the condition of traffic.

Vehicle systems 230 may include a plurality of different systems/subsystems to control operation of vehicle 200. In this example, vehicle systems 230 include steering system 221, throttle system 222, brakes 223, transmission 224, electronic control unit (ECU) 225, propulsion system 226 and vehicle hardware interfaces 227. The vehicle systems 230 may be controlled by AV control systems 240 in autonomous, semi-autonomous or manual mode of vehicle 200. For example, in autonomous or semi-autonomous mode, AV control systems 240, alone or in conjunction with other systems, can control vehicle systems 230 to operate the vehicle in a fully or semi-autonomous fashion. When control is assumed, computing system 210 and AV control system 230 can provide vehicle control systems to vehicle hardware interfaces for controlled systems such as steering angle 221, throttle 222, brakes 223, or other hardware interfaces 227, such as traction force, turn signals, horn, lights, etc. This may also include an assist mode in which the vehicle takes over partial control or activates ADAS controls (e.g., AC control systems 240) to assist the driver with vehicle operation.

Computing system 210 in the illustrated example includes a processor 206, and memory 203. Some or all of the functions of vehicle 200 may be controlled by computing system 210. Processor 206 can include one or more GPUs, CPUs, microprocessors or any other suitable processing system. Processor 206 may include one or more single core or multicore processors. Processor 206 executes instructions 208 stored in a non-transitory computer readable medium, such as memory 203. The computing system 210 may be, for example, the computing component 110 of FIG. 1.

Memory 203 may contain instructions (e.g., program logic) executable by processor 206 to execute various functions of vehicle 200, including those of vehicle systems and subsystems. Memory 203 may contain additional instructions as well, including instructions to transmit data to, receive data from, interact with, and control one or more of the sensors 220, AV control systems 240 and vehicle systems 230. In addition to the instructions, memory 203 may store data and other information used by the vehicle and its systems and subsystems for operation, including operation of vehicle 200 in the autonomous, semi-autonomous or manual modes. For example, memory 203 can include data that has been communicated to the ego vehicle (e.g., via V2V (vehicle-to-vehicle) communication), mapping data, a model of the current or predicted road traffic vehicle network, vehicle dynamics data, computer vision recognition data, and other data which can be useful for the execution of one or more vehicle maneuvers, for example by one or more modules of the AV control systems 240.

Although one computing system 210 is illustrated in FIG. 2, in various applications multiple computing systems 210 can be included. Additionally, one or more systems and subsystems of vehicle 200 can include its own dedicated or shared computing system 210, or a variant thereof. Accordingly, although computing system 210 is illustrated as a discrete computing system, this is for ease of illustration only, and computing system 210 can be distributed among various vehicle systems or components.

Vehicle 200 may also include a (wireless or wired) communication system (not illustrated) to communicate with other vehicles, infrastructure elements, cloud components and other external entities using any of a number of communication protocols including, for example, V2V (vehicle-to-vehicle), V2I (vehicle-to-infrastructure) and V2X (vehicle-to-everything) protocols. Such a wireless communication system may allow vehicle 200 to receive information from other objects including, for example, map data, data regarding infrastructure elements, data regarding operation and intention of surrounding vehicles, and so on. A wireless communication system may allow vehicle 200 to receive updates to data that can be used to execute one or more vehicle control modes, and vehicle control algorithms as discussed herein. Wireless communication system may also allow vehicle 200 to transmit information to other objects and receive information from other objects (such as other vehicles, user devices, or infrastructure). In some applications, one or more communication protocol or dictionaries can be used, such as, for example, the SAE J2935 V2X Communications Message Set Dictionary. In some applications, the communication system may be useful in retrieving and sending one or more data useful in detecting and verifying obstructions, as disclosed herein.

Communication system can be configured to receive data and other information from sensors 220 that is used in determining whether and to what extent control mode blending should be activated. Additionally, communication system can be used to send an activation signal or other activation information to various vehicle systems 230 and AV control systems 240 as part of controlling the vehicle. For example, communication system can be used to send signals to one or more of the vehicle actuators 237 to control parameters, for example, maximum steering angle, throttle response, vehicle braking, torque vectoring, and so on.

In some applications, computing functions for various applications disclosed herein may be performed entirely on computing system 210, distributed among two or more computing systems 210 of vehicle 200, performed on a cloud-based platform, performed on an edge-based platform, or performed on a combination of the foregoing.

Path and planning module 238 can allow for executing one or more vehicle control mode(s), and vehicle control algorithms in accordance with various implementations of the systems and methods disclosed herein.

In operation, path and planning module 238 (e.g., by a driver intent estimation module, not shown) can receive information regarding human control input used to operate the vehicle. As described above, information from sensors 220, actuators 237 and other systems can be used to determine the type and level of human control input. Path and planning module 238 can use this information to predict driver action. Path and planning module 238 can use this information to generate a predicted path and model the road traffic vehicle network. This may be useful in evaluating road conditions, determining and verifying obstructions, and determining traffic conditions. As also described above, information from sensors, and other systems can be used to evaluate road conditions, determine and verify obstructions, and determine traffic conditions. Eye state tracking, attention tracking, or intoxication level tracking, for example, can be used to determine vehicle movement patterns according to inherent human behavior. It can be understood that collected, analyzed, and synchronized sensor data of vehicle 200, including, for example, environmental data and vehicular data of vehicle 200, can contribute to improving the navigation and performance for an ego vehicle as disclosed herein. Driver state can be provided to a risk assessment module 232 to determine the level of risk associated with a location and environmental surrounding of the vehicle 200, and generate a navigation for the vehicle 200 for the parking location. Although not illustrated in FIG. 2, where the assessed risk contributes to determining vehicle movement patterns according to inherent human behaviors, a verification strategy may be generated and provided to vehicle 200 to determine traffic conditions.

Path and planning module 238 can receive state information such as, for example from visibility maps, traffic and weather information, parking information, hazard maps, and local map views. Information from a navigation system can also provide a mission plan including maps and routing to path and planning module 238.

The path and planning module 238 (e.g., by a driver intent estimation module, not shown) can receive this information and predict behavior characteristics within a future time horizon. This information can be used by path and planning module 238 for executing one or more planning decisions. Planning decisions can be based on one or more policy (such as defensive driving policy). Planning decisions can be based on one or more level of autonomy, connected vehicle actions, one or more policy (such as defensive driving policy, cooperative driving policy, such as swarm or platoon formation, leader following, etc.). Path and planning module 238 can generate an expected model for the road traffic hazards and assist in creating a predicted traffic hazard level and verification strategy for vehicles to implement. Path and planning module 238 can generate an expected model for the parking hazards and assist in creating a predicted parking hazard level and parking strategy for vehicles to implement.

Path and planning module 238 can receive risk information from risk assessment module 232. Path and planning module 238 can receive vehicle capability and capacity information from one or more vehicle systems 230. Vehicle capability can be assessed, for example, by receiving information from vehicle hardware interfaces 229 to determine vehicle capabilities and identify a reachable set model. Path and planning module 238 can receive surrounding environment information (e.g., from computer vision module 234, and obstacle avoidance module 239). Path and planning module 238 can apply risk information and vehicle capability and capacity information to trajectory information (e.g., based on a planned trajectory and driver intent) to determine a safe or optimized trajectory for the vehicle given the drivers intent, policies (e.g., safety or vehicle cooperation policies), communicated information, given one or more obstacles in the surrounding environment, road conditions, traffic conditions, etc. Path and planning module 238 can receive parking information (e.g., from computer vision module 234, and risk assessment module 232). This trajectory information can be provided to controller (e.g., ECU 225) to provide partial or full vehicle control in the event of a risk level above threshold. Path and planning module 238 can apply risk information and vehicle capability and capacity information to parking information (e.g., based on parking availability and parking hazard information) to determine a safe or optimal parking location for the vehicle given the vehicle's security system capabilities and policies (e.g., safety or vehicle cooperation policies), communicated information, given one or more parking locations in the surrounding environment, crime data, etc. Information from risk assessment module 232 can be used to generate countermeasures described herein. A signal from risk assessment module 232 can trigger ECU 225 or another AV control system 230 to take over partial or full control of the vehicle.

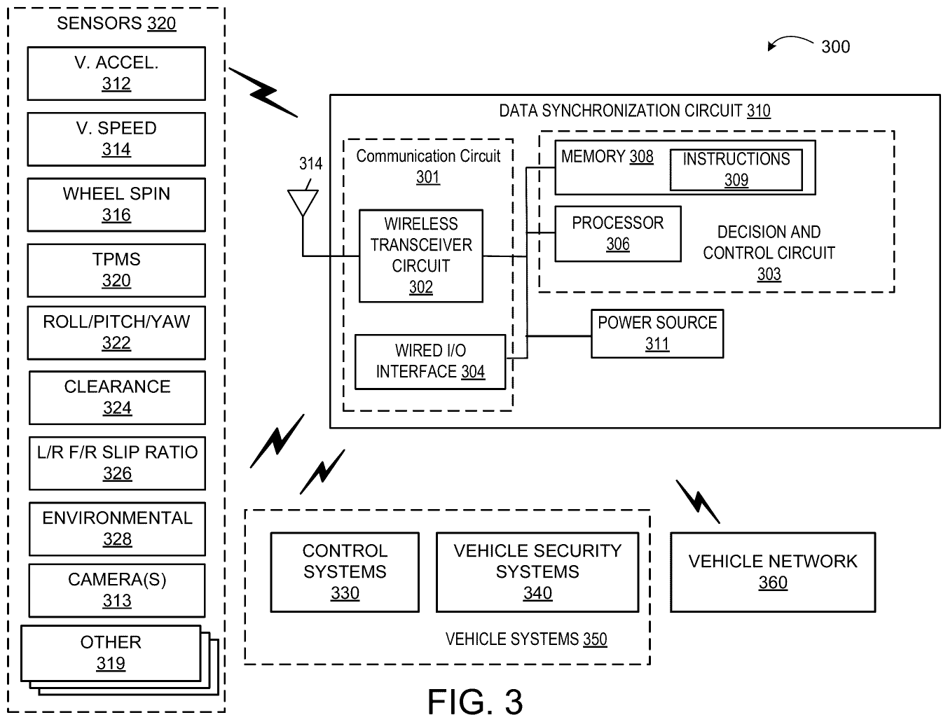

FIG. 3 illustrates an example architecture for receiving, analyzing, and synchronizing data for a vehicle described herein. Referring now to FIG. 3, in this example, a data synchronization system 300 includes a data synchronization circuit 310, a plurality of sensors 320, and a plurality of vehicle systems 350. Also included are various elements of vehicle network 360 with which the data synchronization system 300 can communicate. It can be understood that a vehicle network 360 can include various elements that are important in a vehicle network, such as vehicles, pedestrians (with or without connected devices that can include aspects of data synchronization system 300 disclosed herein), infrastructure (e.g., traffic signals, sensors, such as traffic cameras, databases, central servers, weather sensors), traffic, road conditions, landscapes, terrains, global location positioning, coordinates, weather, temperature, and other environmental surroundings and elements around vehicles. Other elements of the vehicle network 360 can include connected elements at workplaces, or the home (such as vehicle chargers, connected devices, appliances, etc.).

Data synchronization system 300 can be implemented as and include one or more components of the vehicle 200 shown in FIG. 2. Sensors 320, vehicle systems 350, and elements of vehicle security network 360, can communicate with the data synchronization circuit 310 via a wired or wireless communication interface. As previously alluded to, elements of vehicle security network 360 can correspond to connected or unconnected devices, infrastructure (e.g., traffic signals, sensors, such as traffic cameras, weather sensors), vehicles, pedestrians, objects, etc. that are in a broad or immediate vicinity of an ego-vehicle (e.g., vehicle 150, vehicle 200) or otherwise important to the vehicle network 360 (such as remote infrastructure). Although sensors 320, vehicle systems 350, and vehicle network 360, are depicted as communicating with data synchronization circuit 310, they can also communicate with each other, as well as with other vehicle systems 350 and directly with element of a vehicle network 360.

Data as disclosed herein can be communicated to and from the data synchronization circuit 310. For example, various infrastructure (example element of vehicle network 360) can include one or more databases, such as vehicle infrastructure data, environmental data, traffic data, landscape data, road condition data, and weather data. This data can be communicated to the circuit 310, and such data can be updated based on outcomes for one or more actions or changes to the vehicle network, vehicle system, environmental data, and vehicular data from sensors 320 (e.g., analysis of objects and infrastructures) of the ego vehicle. All of this data can be included in and contribute to predictive analytics (e.g., by machine learning) of traffic and hazards, and generation of a navigational plan. Similarly, models, circuits, and predictive analytics can be updated according to various outcomes.

Data synchronization circuit 310 can evaluate environmental data (i.e., landscape, location, weather, temperature, road conditions, etc.), parking data (i.e., time, location and duration), crime data, vehicle data, surveillance data, actions occurring to the ego vehicle, synchronize such data, and generate strategic navigational settings as described herein. As will be described in more detail herein, the collection, analysis, and synchronization of data, and generation of a navigational plan and a performance plan can have one or more contributing factors. Various sensors 320, vehicle systems 350, and vehicle network 360 elements may contribute to gathering data for data synchronization to be used to generate a navigational plan and a performance plan for an ego vehicle. For example, the data synchronization circuit 310 can include at least one of a decision and control circuit, such as decision and control circuit 303. The data synchronization circuit 310 can be implemented as an ECU or as part of an ECU such as, for example electronic control unit 225. In other applications, data synchronization circuit 310 can be implemented independently of the ECU, for example, as another vehicle system.

Data synchronization circuit 310 can be configured to evaluate road conditions, detect obstructions, determine traffic conditions, determine driver discomfort levels and appropriately respond by generating strategic navigational and performance settings. Data synchronization circuit 310 may include a communication circuit 301 (including either or both of a wireless transceiver circuit 302 with an associated antenna 314 and wired input/output (I/O) interface 304 in this example), a decision and control circuit 303 (including a processor 306 and memory 308 in this example) and a power source 311 (which can include power supply). It is understood that the disclosed data synchronization circuit 310 can be compatible with and support one or more standard or non-standard messaging protocols.

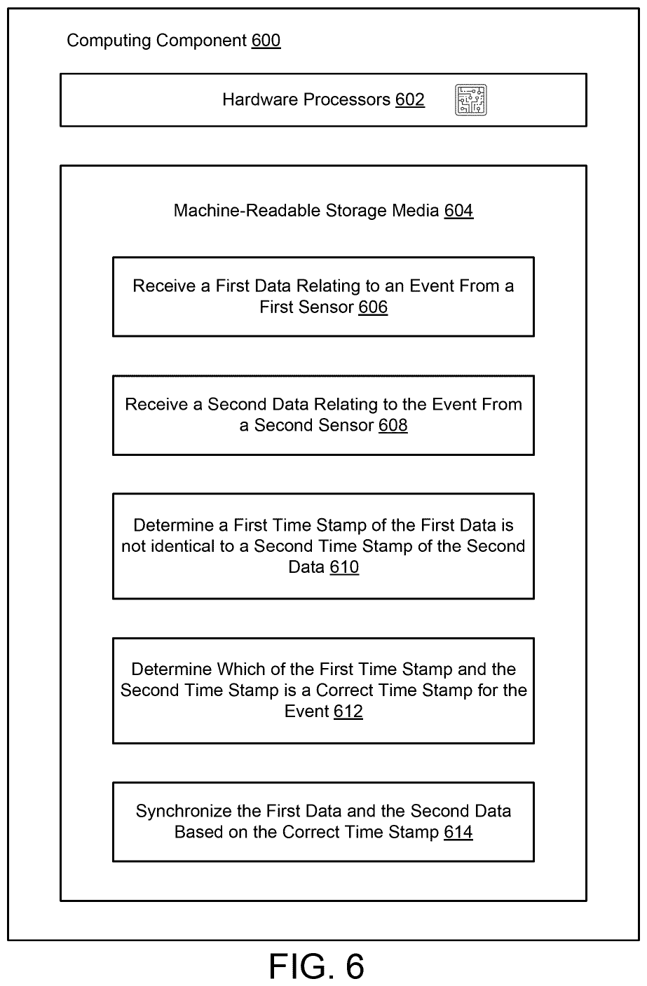

Components of data synchronization circuit 310 are illustrated as communicating with each other via a data bus, although other communication in interfaces can be included. Decision and control circuit 303 can be configured to control one or more aspects of receiving data, analyzing data, synchronizing data, and generating a navigational plan and a performance plan for an ego vehicle. Decision and control circuit 303 can be configured to execute one or more steps described with reference to FIG. 6.

Processor 306 can include a GPU, CPU, microprocessor, or any other suitable processing system. Processor 306 may include one or more single core or multicore processors. Processor 306 executes instructions 309 stored in a non-transitory computer readable medium, such as memory 308. Memory 308 may contain instructions 309 (e.g., program logic) executable by processor 306 to execute various functions of data synchronization system 300, including those of vehicle systems and subsystems. Memory 308 may contain additional instructions as well, including instructions to transmit data to, receive data from, interact with, and control one or more of the sensors 320 and vehicle systems 350. In addition to the instructions, memory 308 may store data and other information used by the data synchronization system 300 and its systems and subsystems for operation. For example, memory 308 can include data that has been communicated to the ego vehicle (e.g. via V2X communication), vehicle data, environmental data, vehicle dynamics data, computer vision recognition data, and other data which can be useful for the execution of one or more collection of data, analysis of data, synchronization of data, and generation of navigational and performance plans.

The memory 308 may include one or more various forms of memory or data storage (e.g., flash, RAM, etc.) that may be used to store the calibration parameters, images (analysis or historic), point parameters, instructions and variables for processor 306 as well as any other suitable information. Memory 308 can be made up of one or more modules of one or more different types of memory, and may be configured to store data and other information as well as operational instructions 309 that may be used by the processor 306 to execute one or more functions of data synchronization circuit 310. For example, data and other information can include vehicle infrastructure data (i.e., the parameters of an ego vehicle), vehicle security data (i.e., the components used for vehicle security), environmental data (i.e., landscape, location, weather, temperature, road conditions, etc.), vehicular data (i.e., speed, acceleration, direction, handling, torque, trajectory, force, tire grip, traction, steering, etc. of an ego vehicle), etc. The data can also include values for signals of one or more sensors 320 useful in collecting, analyzing, and synchronizing environmental and vehicular data, and generating navigational and performance settings for the ego vehicle to perform. Operational instruction 309 can contain instructions for executing logical circuits, models, and methods as described herein.

Although the example of FIG. 3 is illustrated using processor and memory circuitry, as described below with reference to circuits disclosed herein, decision and control circuit 303 can be implemented utilizing any form of circuitry including, for example, hardware, software, or a combination thereof. By way of further example, one or more processors, controllers, ASICs, PLAS, PALs, CPLDs, FPGAs, logical components, software routines or other mechanisms might be implemented to make up a data synchronization circuit 310. Components of decision and control circuit 303 can be distributed among two or more decision and control circuits 303, performed on other circuits described with respect to data synchronization circuit 310, be performed on devices (such as cell phones), performed on a cloud-based platform (e.g., part of infrastructure), performed on distributed elements of the vehicle network 360, such as at multiple vehicles, user device, central servers, performed on an edge-based platform, and performed on a combination of the foregoing.

Communication circuit 301 may include either or both a wireless transceiver circuit 302 with an associated antenna 314 and a wired I/O interface 304 with an associated hardwired data port (not illustrated). As this example illustrates, communications with data synchronization circuit 310 can include either or both wired and wireless communications circuits 301. Wireless transceiver circuit 302 can include a transmitter and a receiver (not shown), e.g., an obstruction detection and verification broadcast mechanism, to allow wireless communications via any of a number of communication protocols such as, for example, WiFi (e.g., IEEE 802.11 standard), Bluetooth®, near field communications (NFC), Zigbee, and any of a number of other wireless communication protocols whether standardized, proprietary, open, point-to-point, networked or otherwise. Antenna 314 is coupled to wireless transceiver circuit 302 and is used by wireless transceiver circuit 302 to transmit radio signals wirelessly to wireless equipment with which it is connected and to receive radio signals as well. These RF signals can include information of almost any sort that is sent or received by data synchronization circuit 310 to/from other components of the ego vehicle, such as sensors 320, vehicle systems 350, infrastructure (e.g., servers cloud-based systems), and other devices or elements of vehicle security network 360. These RF signals can include information of almost any sort that is sent or received by the ego vehicle.

Wired I/O interface 304 can include a transmitter and a receiver (not shown) for hardwired communications with other devices. For example, wired I/O interface 304 can provide a hardwired interface to other components, including sensors 320 and vehicle systems 350. Wired I/O interface 304 can communicate with other devices using Ethernet or any of a number of other wired communication protocols whether standardized, proprietary, open, point-to-point, networked or otherwise.

Power source 311 such as one or more of a battery or batteries (such as, e.g., Li-ion, Li-Polymer, NiMH, NiCd, NiZn, and NiH2, to name a few, whether rechargeable or primary batteries), a power connector (e.g., to connect to vehicle supplied power, another vehicle battery, alternator, etc.), an energy harvester (e.g., solar cells, piezoelectric system, etc.), or it can include any other suitable power supply. It is understood power source 311 can be coupled to a power source of the ego vehicle, such as a battery and alternator. Power source 311 can be used to power the data synchronization circuit 310.

Sensors 320 can include one or more of the previously mentioned sensors 220 of FIG. 2. Sensors 320 can include one or more sensors that may or not otherwise be included on a standard vehicle (e.g., vehicle 200) with which the data synchronization circuit 310 is implemented. In the illustrated example, sensors 320 include vehicle acceleration sensors 312, vehicle speed sensors 314, wheelspin sensors 316 (e.g., one for each wheel), a tire pressure monitoring system (TPMS) 320, accelerometers such as a 3-axis accelerometer 322 to detect roll, pitch and yaw of the vehicle, vehicle clearance sensors 324, left-right and front-rear slip ratio sensors 326, environmental sensors 328 (e.g., to detect weather, salinity or other environmental conditions), and camera(s) 313 (e.g., front rear, side, top, bottom facing). Additional sensors 319 can also be included as may be appropriate for a given implementation data synchronization system 300.

Vehicle systems 350 can include any of a number of different vehicle components or subsystems used to control or monitor various aspects of the ego vehicle and its performance. For example, it can include any or all of the aforementioned vehicle systems 230 and control systems 240 shown in FIG. 2. The vehicle security system 340 of vehicle systems 350 may control components, such as sensors, of an ego vehicle to monitor and collect surveillance data of the ego vehicle. In this example, the vehicle systems 350 may include a GPS or other vehicle positioning system 218.

During operation, data synchronization circuit 310 can receive information from various vehicle sensors 320, vehicle systems 350, and vehicle security network 360 to analyze and synchronize sensor data, and generate navigational and performance settings for an ego vehicle to perform. Also, the driver, owner, and operator of the ego vehicle may manually trigger one or more processes described herein for collecting, receiving, and synchronizing a plurality of sensor data, and generating navigational and performance settings for the ego vehicle. Communication circuit 301 can be used to transmit and receive information between the data synchronization circuit 310, sensors 320 and vehicle systems 350. Also, sensors 320 and data synchronization circuit 310 may communicate with vehicle systems 350 directly or indirectly (e.g., via communication circuit 301 or otherwise). Communication circuit 301 can be used to transmit and receive information between data synchronization circuit 310, one or more other systems of an ego vehicle (i.e., vehicle 200), but also other elements of a vehicle security network 360, such as vehicles, devices (e.g., mobile phones), systems, networks (such as a communications network and central server), and infrastructure.

In various applications, communication circuit 301 can be configured to receive data and other information from sensors 320, vehicle systems 350, and vehicle network 360 that is used to collect, analyze, and synchronize sensor data, and generate navigational and performance settings for an ego vehicle. As one example, when data is received from an element of vehicle network 360 (such as from a driver's user device), communication circuit 301 can be used to send an activation signal and activation information to one or more vehicle systems 350 or sensors 320 for the ego vehicle to analyze and synchronize sensor data. For example, it may be useful for vehicle systems 350, vehicle network 360 or sensors 320 to provide data useful in performing data synchronization to improve in the generation of navigational and performance settings for the ego vehicle.

Alternatively, data synchronization circuit 310 can be continuously receiving information from vehicle system 350, sensors 320, other vehicles, devices and infrastructure (e.g., those that are elements of vehicle network 360). Further, upon receiving new sensor data, such as, for example, environmental data associated to an ego vehicle, communication circuit 301 can send a signal to other components of the ego vehicle, infrastructure, or other elements of the vehicle network based on the new sensor data. For example, the communication circuit 301 can send a signal to a vehicle system 350 that indicates a control input for performing one or more calculations, analysis, and synchronizations of sensor data for an ego vehicle. The calculations, analysis, and synchronization of the sensor data may generate a new and more efficient navigational and performance settings for the ego vehicle to implement.

The examples of FIGS. 2 and 3 are provided for illustration purposes only as examples of vehicle 200 and data synchronization system 300 with which applications of the disclosed technology may be implemented. One of ordinary skill in the art reading this description will understand how the disclosed applications can be implemented with vehicle platforms. The data synchronization system 300 may be, for example, the computing component 110 of FIG. 1, and the computing system 210 of FIG. 2.

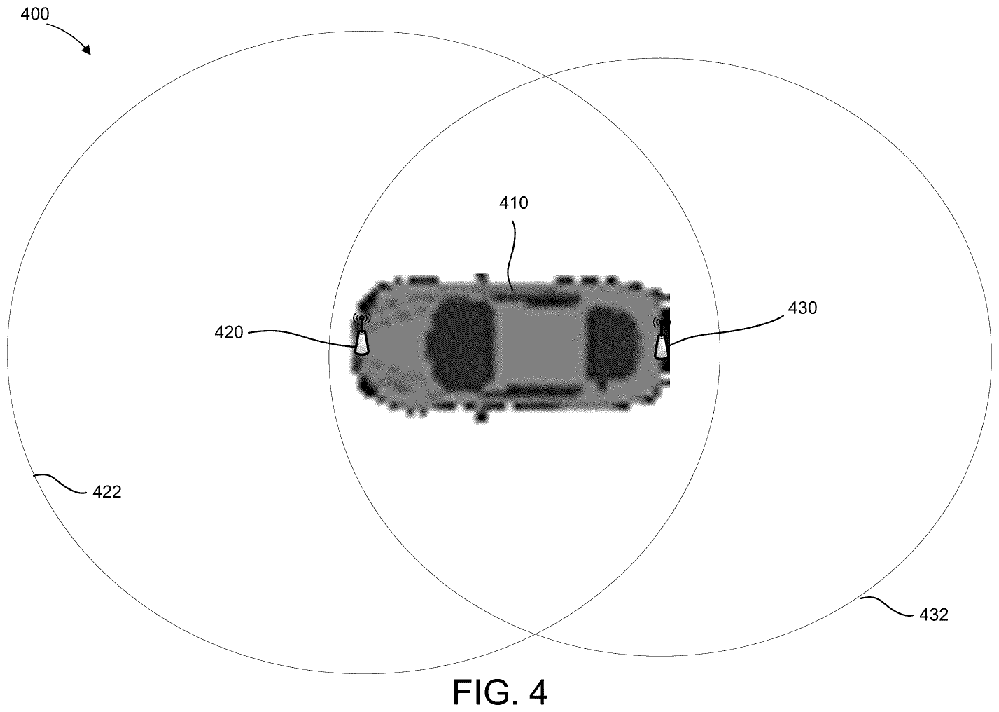

FIG. 4 illustrates an example data synchronization system 400. The data synchronization system 400 may be configured to synchronize data sets collected and received by an ego vehicle, such as, for example, vehicle 410 and vehicle 150 of FIG. 1. The data synchronization system 400 may use one or more sensors, such as, for example, sensors 420 and 430, to collect and receive data sets. The one or more sensors, such as sensors 420 and 430, may be located on the vehicle 410. The one or more sensors may be located outside the vehicle 410 and the vehicle 410 may be able to communicate to the one or more sensors to receive data. The one or more sensors, such as sensors 420 and 430, may be located at different locations on and off the ego vehicle. The one or more sensors, such as sensors 420 and 430, may include at least one of a camera, image sensor, radar sensor, environmental sensor, light detection and ranging (LIDAR) sensor, electromyography sensor, motion sensor, pressure sensor, position sensor, audio sensor, infrared sensor, microwave sensor, optical sensor, haptic sensor, magnetometer, communication system and global positioning system (GPS).

The data sets collected and received by the vehicle 410 using one or more sensors, such as sensors 420 and 430, may include, for example, environmental data, vehicular data, and driver data. The environmental data may include, for example, a road condition, traffic, location, coordinates, population, landscape, landmark, terrain, territory, weather, temperature, humidity, pollution, habitat, and other environmental surroundings around the ego vehicle. The vehicular data may include a speed, acceleration, direction, handling, torque, trajectory, force, tire grip, traction, and steering of the ego vehicle. The driver data may include driver identification, driver performance characteristics, and driver setting preference.

The data sets collected and received by the vehicle 410 from the sensors 420 and 430 may be associated with one or more events relating to and consisting of one or more objects, subjects, and/or features that the vehicle 410 encounters while traveling and while stationary (i.e., parked). An element may be a detection of an element in an environment, such as, for example, an object, subject, and/or feature, of the vehicle. An object and subject may include, for example, the ego vehicle, another surrounding vehicle, a pedestrian, building, obstacle, road, traffic sign, light pole, landmark, and other objects and subjects. A feature may include, for example, the speed of the ego vehicle, steering of the ego vehicle, tire traction of the ego vehicle, speed of another surrounding vehicle, position of an obstacle, structure of a building, shape of a landmark, weather at a location, traffic on a road, and other features of objects and subjects.

Each sensor, including sensors 420 and 430, may collect data pertaining to one or more events relating to and consisting of one or more objects, subjects, and/or features within a perimeter, such as, for example, perimeters 422 and 432, respectively. The perimeter of a sensor may be based on the type of the sensor being used. The range of the perimeter of a sensor may be preset or may be adjusted according to one or more settings inputted and/or selected by an entity, such as, for example, a driver of the ego vehicle, an admin of the data synchronization system, a law enforcement agency, a security agency, etc. The perimeters of two or more sensors may overlap and collect data in the same area and location. The data being collected in the same area and location by two or more sensors with overlapping perimeters may be associated with different events, objects, subjects, and/or features. The data being collected in the same area and location by two or more sensors with overlapping perimeters may be associated with the same event relating to and consisting of one or more objects, subjects, and/or features. For example, sensor 420 may collect data within perimeter 422 and sensor 432 may collect data within perimeter 432. The perimeter 422 for sensor 420 may be larger than the perimeter 432 for sensor 430. The data synchronization system 400 may use algorithms, such as machine learning (ML) algorithms and models, to analyze and compare data sets to determine if data sets are related to and directed towards the same events, objects, subjects, and/or features. Many variations are possible.

The data synchronization system 400 may be, for example, the computing component 110 of FIG. 1, the computing system 210 of FIG. 2, and the data synchronization system 300 of FIG. 3.

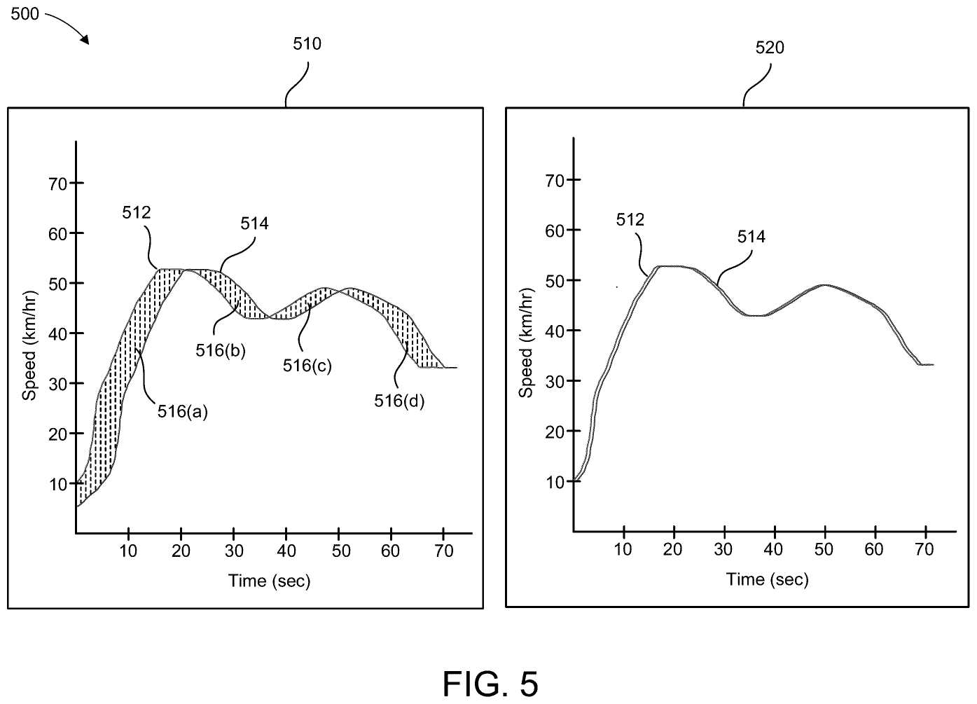

FIG. 5 illustrates an example data synchronization system 500. The data synchronization system 500 may be configured to synchronize data sets collected and received by an ego vehicle, such as, for example, vehicle 410 of FIG. 4 and vehicle 150 of FIG. 1. As alluded to in FIG. 4, each sensor, including sensors 420 and 430 of FIG. 4, may have their own respective data that may be associated to the same one or more events relating to and consisting of one or more objects, subjects, and/or features. The data synchronization system 500 may determine whether the data set of sensor 420 (i.e., first data set) and the data set of the sensor 430 (i.e., second data set) are associated to the same event relating to and consisting of one or more objects, subjects, and/or features. The data synchronization system 400 may analyze the first data set of sensor 420 against the second data set of sensor 430 to determine if they are related to and directed towards the same event relating to and consisting of one or more object, subject, and/or feature. The data synchronization system 500 may use algorithms, such as machine learning (ML) algorithms and models, to analyze and compare data sets to determine if data sets are related to and directed towards the same event relating to and consisting of one or more objects, subjects, and/or features.

Upon a determination that the first data set of the sensor 420 and the second data set of the sensor 430 are associated to the same one or more events relating to and consisting of one or more objects, subjects, and/or features, the data synchronization system 500 may graph each data set to the same graphical display to determine the curve, axis, and boundary points to be used for the data sets. For example, the data synchronization system 500 may graph the first data set of the sensor 420, i.e., graph 512, and the second data set of the sensor 430, i.e., graph 514, on chart 510. The data synchronization system 500 may determine that the first data set of the sensor 420 and the second data set of the sensor 430 are both associated to the speed, i.e., kilometers (km) per hour (hr), of the ego vehicle with respect to time, i.e., seconds (sec).

Each data set of a sensor may include a time stamp. The time stamp of the data set may indicate the time that the data set was collected and received by the data synchronization system 500 from the respective sensor. Upon a determination that the first data set of the sensor 420 and the second data set of the sensor 430 are associated to the same one or more events, objects, subjects, and/or features, the data synchronization system 500 may determine the time stamp of the first data set (i.e., first time stamp) and the time stamp of the second data set (i.e., second time stamp). The data synchronization system 500 may compare the first time stamp of the first data set to the second time stamp of the second data to determine whether the first time stamp is identical to the second time stamp. For example, the first time stamp of the first data set of the sensor 420 may be a duration of 68 seconds (as shown by graph 512), starting at a time of 13:15:32 of the day. The second time stamp of the second data set of the sensor 430 may be a duration of 68 seconds (as shown by graph 514), starting at a time of 13:15:37 of the day.

Even if the first time stamp and the second time stamp do appear to be identical by having the same start and end times, the first time stamp and the second time stamp may not actually be identical as there may be a delay with a first local clock of the first sensor and/or a delay with a second local clock of the second sensor that may have affected the first and/or second time stamps. To determine whether the first time stamp is actually identical to the second time stamp, the data synchronization system 500 may compare the first time stamp to a first local clock of the first sensor. The data synchronization system 500 may also compare the second time stamp to a second local clock of the second sensor. The data synchronization system 500 may determine if there is a time delay between at least the first time stamp and the first local clock or the second time stamp and the second local clock. The data synchronization system 500 may determine the first time stamp is not identical to the second time stamp according to the determined time delay.

Upon a determination that the first time stamp of the first data set is not identical to the second time stamp of the second data set, the data synchronization system 500 may determine which of the first time stamp and the second time stamp is the correct time stamp. The correct time stamp is a time that the one or more events, objects, subjects, and/or features of the first data set and the second data set is first identified and detected by either of the sensors 420 or 430. For example, the data synchronization system 500 may determine that the ego vehicle first obtained the first data set associated with the same event relating to and consisting of one or more objects, subjects, and/or features as the second data set, as shown in chart 510 of graphs 512 and 514 of the first data set of the sensor 420 and the second data set of the sensor 430, respectively. The data synchronization system 500 may determine that the correct time stamp between the first data set of the sensor 420 and the second data set of the sensor 430 is the first time stamp. The correct time stamp may be used to determine an accurate location of an object and/or subject of an event in and environment.

Upon a determination of the correct time stamp between the first time stamp and the second time stamp, the data synchronization system 500 may synchronize the first data set of the sensor 420 and the second data set of the sensor 430 according to the correct time stamp. The data synchronization system 500 may synchronize the first data set and the second data set by adjusting at least one of the first data set and the second data set according to the correct time stamp and an area under the curve (AUC) difference between the graph 512 of the first data set and the graph 514 of the second data set. The AUC of a data set, such as the first data set or second data set, may be the area bounded by a curve, axis, and boundary points of a data set. For example, the AUC of the first data set, i.e., first AUC, may be the area under the graph 512. The AUC of the second data, i.e., second AUC, may be the area under the graph 514.

To determine the AUC difference between the first data set and the second data set, the data synchronization system 500 analyze the graph 512 in the chart 510 of the first data set to determine a curve, axis, and boundary points of the first data set. The data synchronization system 500 may use the curve, axis, and boundary points of the first data set to determine the first AUC of the first data set. The data synchronization system 500 may analyze the graph 514 in the chart 510 of the second data set to determine a curve, axis, and boundary points of the second data set. The data synchronization system 500 may use the curve, axis, and boundary points of the second data set to determine the second AUC of the second data set. The data synchronization system 500 may analyze the first AUC against the second AUC to determine the AUC difference between the first data set and the second data set. The AUC difference may include one or more absolute values of the difference between the first AUC of the first data set and the second AUC of the second data set. For example, the AUC difference between the first data set of the sensor 410 and the second data set of the sensor 430 may include the areas in between graphs 512 and 514 in chart 510, such as, for example, areas 516(a), 516(b), 516(c), and 516(d).

The data synchronization system 500 may determine the AUC difference between the first data set and the second data set over a time series. The time series can be the full length of time that the first data set and the second data set are both associated with the same one or more events, objects, subjects, and/or features. The time series may be a preset length of time in determining the AUC of a data set. The time series may be inputted by an entity, such as, for example, a driver of the ego vehicle, an admin of the data synchronization system, a law enforcement agency, a security agency, etc. Using the AUC difference and the correct time stamp, the data synchronization system 500 may synchronize the first data set and the second data set by using the AUC difference to correlate the curves of the first data set and the second data set over the time series. The data synchronization system 500 may determine the smallest value of the one or more absolute values of the AUC difference between the first data set and the second data set. The data synchronization system 500 may synchronize the first data set and the second data set by using the smallest absolute value of the AUC difference to shift at least one of the first data set and the second data set for the time series. For example, the data synchronization system 500 may determine the smallest value between the areas 516(a), 516(b), 516(c), and 516(d) of the AUC difference between graph 512 of the first data set and graph 514 of the second data set. The data synchronization system 500 may determine that the smallest value of the AUC difference would create a shift of five (5) seconds between the graph 512 of the first data set and graph 514 of the second data set. With data synchronization system 500 determining that the correct time stamp is the first time stamp of the first data set, the data synchronization system 500 may shift the graph 514 of the second data set towards the graph 512 of the first data set. Once the data synchronization system 500 has shifted the graph 514 of the second data set towards to the graph 512 of the first data set, the graphs 512 and 514 may be displayed more closely to each other, as displayed in chart 520.

The data synchronization system 500 may use the AUC difference between the first data set and the second data set to train a machine learning (ML) model. The ML model may use one or more ML algorithms to evaluate data and synchronize data sets that are associated with the same event relating to and consisting of one or more objects, subjects, and/or features. Synchronizing data sets, including, for example, the first data set and the second data set, that are associated with the same one or more events, objects, subjects, and/or features for a period of time may increase the accuracy in the collection, analysis, determination, and recordation of data associated with events, objects, subjects, and/or features. The synchronized data sets may also be used to correct any time delays or lags between the local clocks of sensors, which may also increase the accuracy in the collection, analysis, determination, and recordation of data associated with events, objects, subjects, and/or features. Such accurate data with accurate time stamps may be used to accurately identify and detect particular events, objects, subjects, and/or features in an environment at the precise time and location that such events, objects, subjects, and/or features were identified and detected by an ego vehicle. Entities, such as, for example, the driver of the ego vehicle, law enforcement, security agency, mechanics, paramedics, emergency responders, tow trucks, news agency, etc., may be able to use the synchronized data to more efficiently and effectively relay and respond to the events, objects, subjects, and/or features identified and detected by the ego vehicle. The accurate data, along with the precise time and location of events, objects, subjects, and/or features, may be used to update a map of the environment where the updated map may be used to navigate a vehicle more efficiently through the environment. Many variations are possible.

The data synchronization system 500 may be, for example, the computing component 110 of FIG. 1, the computing system 210 of FIG. 2, the data synchronization system 300 of FIG. 3, and the data synchronization system 400 of FIG. 4.

FIG. 6 illustrates an example computing component 600 that includes one or more hardware processors 602 and machine-readable storage media 604 storing a set of machine-readable/machine-executable instructions that, when executed, cause the hardware processor(s) 602 to perform an illustrative method for synchronizing sensor data for a vehicle. It should be appreciated that there can be additional, fewer, or alternative steps performed in similar or alternative orders, or in parallel, within the scope of the various examples discussed herein unless otherwise stated. The computing component 600 may be implemented as the computing component 110 of FIG. 1, the computing system 210 of FIG. 2, the data synchronization system 300 of FIG. 3, the data synchronization system 400 of FIG. 4, and the data synchronization system 500 of FIG. 5.

At step 606, the hardware processor(s) 602 may execute machine-readable/machine-executable instructions stored in the machine-readable storage media 604 to receive a first data relating to an event. An ego vehicle may be traveling on a path. The ego vehicle may include, for example, an automobile, truck, motorcycle, bicycle, scooter, moped, recreational vehicle and other like on- or off-road vehicles. The ego vehicle may include, for example, an autonomous, semi-autonomous and manual operation. While traveling on the path, the ego vehicle may collect and receive data using a data synchronization system.

The data synchronization system may collect and receive data from one or more sensors, including the first sensor. Each sensor may collect and provide an individual set of data that is different from the data collected and provided by other sensors. Each sensor's data may be associated to at least one event that may be a detection of an element in an environment, such as, for example, at least one object, subject, and/or feature. The at least one object and/or subject may include, for example, the ego vehicle, another surrounding vehicle, a pedestrian, building, obstacle, road, traffic sign, light pole, landmark, and other objects and subjects that the ego vehicle may encounter while traveling. Each sensor's data may be associated to at least one event relating to and consisting of at least one feature of an object and/or subject, including, for example, the speed of the ego vehicle, steering of the ego vehicle, tire traction of the ego vehicle, speed of another surrounding vehicle, position of an obstacle, structure of a building, shape of a landmark, weather at a location, traffic on a road, and other features of objects and subjects that the ego vehicle may encounter while traveling.

More than one sensor may have their own respective data that may be associated to the same event relating to and consisting of one or more objects, subjects, and/or features. The data synchronization system may determine whether the data of each of a plurality of sensors are associated to the same event relating to and consisting of one or more objects, subjects, and/or features. The data synchronization system may analyze the plurality of data to determine if they are related to and directed towards the same event relating to and consisting of one or more objects, subjects, and/or features.

The data synchronization system may collect and receive data including, for example, environmental data, vehicular data, and driver data. The environmental data may include, for example, a road condition, traffic, location, coordinates, population, landscape, landmark, terrain, territory, weather, temperature, humidity, pollution, habitat, and other environmental surroundings around the ego vehicle. The vehicular data may include a speed, acceleration, direction, handling, torque, trajectory, force, tire grip, traction, and steering of the ego vehicle. The driver data may include driver identification, driver performance characteristics, and driver setting preference.

The data synchronization system may collect and receive data from one or more sensors, including a first sensor and a second sensor. The one or more sensors may be located on the ego vehicle. The one or more sensors may be located outside the ego vehicle and the ego vehicle may be able to communicate to the one or more sensors to receive data. The one or more sensors may be located at different locations on and off the ego vehicle. The one or more sensors may include at least one of a camera, image sensor, radar sensor, environmental sensor, light detection and ranging (LiDAR) sensor, electromyography sensor, motion sensor, pressure sensor, position sensor, audio sensor, infrared sensor, microwave sensor, optical sensor, haptic sensor, magnetometer, communication system and global positioning system (GPS).

The data synchronization system may receive first data from a first sensor. The first sensor may be located on the ego vehicle at a first position. The first data may include environmental data, vehicular data, and driver data. The first data of the first sensor may include a first time stamp, with the first time stamp indicating the time the first data was collected and received.

At step 608, the hardware processor(s) 602 may execute machine-readable/machine-executable instructions stored in the machine-readable storage media 604 to receiving a second data relating to the event. The data synchronization system may receive second data from a second sensor. The second sensor may be located on the ego vehicle at a second position. The second position of the second sensor may be different from the first position of the first sensor. The second data may include environmental data, vehicular data, and driver data. The second data of the second sensor may include a second time stamp, with the second time stamp indicating the time the second data was collected and received.

The data synchronization system may collect and receive data from one or more sensors, including the first sensor and the second sensor. Each sensor may collect and provide an individual set of data that is different from the data collected and provided by other sensors. Each sensor's data may be associated to at least one event that may be a detection of an element in an environment, such as, for example, at least one object, subject, and/or feature. The at least one object and/or subject may include, for example, the ego vehicle, another surrounding vehicle, a pedestrian, building, obstacle, road, traffic sign, light pole, landmark, and other objects and subjects that the ego vehicle may encounter while traveling. Each sensor's data may be associated to at least one event relating to and consisting of at least one feature of an object and/or subject, including, for example, the speed of the ego vehicle, steering of the ego vehicle, tire traction of the ego vehicle, speed of another surrounding vehicle, position of an obstacle, structure of a building, shape of a landmark, weather at a location, traffic on a road, and other features of objects and subjects that the ego vehicle may encounter while traveling.

More than one sensor, including the first sensor and the second sensor, may have their own respective data, including the first data of the first sensor and the second data of the second sensor, that may be associated to the same event relating to and consisting of one or more objects, subjects, and/or features. The data synchronization system may determine whether the first data of the first sensor and the second data of the second sensor are associated to the same event relating to and consisting of one or more objects, subjects, and/or features. The data synchronization system may analyze the first data and the second data to determine if they are related to and directed towards the same event relating to and consisting of one or more objects, subjects, and/or features.

At step 610, the hardware processor(s) 602 may execute machine-readable/machine-executable instructions stored in the machine-readable storage media 604 to determine the first time stamp is not identical to the second time stamp. The first data of the first sensor may include a first time stamp, with the first time stamp indicating the time the first data was collected and received. The second data of the second sensor may include a second time stamp, with the second time stamp indicating the time the second data was collected and received. Upon a determination that the first data and the second data are associated to the same event relating to and consisting of one or more objects, subjects, and/or features, the data synchronization system may determine the first time stamp of the first data and the second time stamp of the second data. The data synchronization system may compare the first time stamp of the first data to the second time stamp of the second data to determine whether the first time stamp is identical to the second time stamp.

Even if the first time stamp and the second time stamp do appear to be identical by having the same start and end times, the first time stamp and the second time stamp may not actually be identical as there may be a delay with a first local clock of the first sensor and/or a delay with a second local clock of the second sensor that may have affected the first and/or second time stamps. To determine whether the first time stamp is actually identical to the second time stamp, the data synchronization system may compare the first time stamp to a first local clock of the first sensor. The data synchronization system may also compare the second time stamp to a second local clock of the second sensor. The data synchronization system may determine if there is a time delay between at least the first time stamp and the first local clock or the second time stamp and the second local clock. The data synchronization system may determine the first time stamp is not identical to the second time stamp according to the determined time delay.

At step 612, the hardware processor(s) 602 may execute machine-readable/machine-executable instructions stored in the machine-readable storage media 604 to determine which of the first time stamp and the second time stamp is a correct time stamp. Upon a determination that the first time stamp of the first data is not identical to the second time stamp of the second data, the data synchronization system may determine which of the first time stamp and the second time stamp is the correct time stamp for the event. The correct time stamp is a time that the event relating to and consisting of one or more objects, subjects, and/or features of the first data and the second data is first detected by either the first sensor or the second sensor. The correct time stamp may be used to determine an accurate location of an element, such as, for example, an object, subject, and/or feature, of the event in the environment.

At step 614, the hardware processor(s) 602 may execute machine-readable/machine-executable instructions stored in the machine-readable storage media 604 to synchronize the first data and the second data. Upon a determination of the correct time stamp between the first time stamp and the second time stamp, the data synchronization system may synchronize the first data and the second data according to the correct time stamp. The data synchronization system may synchronize the first data and the second data by adjusting at least one of the first data and the second data according to the correct time stamp and an area under the curve (AUC) difference between the first data and the second data. The AUC of a data set, such as the first data or second data, may be the area bounded by a curve, axis, and boundary points of a data set.

Each data set may be graphed by the data synchronization system to determine the curve, axis, and boundary points to be used to determine the AUC of the respective data set. To determine the AUC difference between the first data and the second data, the data synchronization system may graph the first data and the second data. The data synchronization system may analyze the graph of the first data to determine a curve, axis, and boundary points of the first data. The data synchronization system may use the curve, axis, and boundary points of the first data to determine the first AUC of the first data. The data synchronization system may analyze the graph of the second data to determine a curve, axis, and boundary points of the second data. The data synchronization system may use the curve, axis, and boundary points of the second data to determine the second AUC of the second data. The data synchronization system may analyze the first AUC against the second AUC to determine the AUC difference between the first data and the second data. The AUC difference may include one or more absolute values of the difference between the first AUC of the first data and the second AUC of the second data.

The data synchronization system may determine the AUC difference between the first data and the second data over a time series. The time series can be the full length of time that the first data and the second data are both associated with the same event relating to and consisting of one or more objects, subjects, and/or features. The time series may be a preset length of time in determining the AUC of a data set. The time series may be inputted by an entity, such as, for example, a driver of the ego vehicle, an admin of the data synchronization system, a law enforcement agency, a security agency, etc. Using the AUC difference and the correct time stamp, the data synchronization system may synchronize the first data and the second data by using the AUC difference to correlate the curves of the first data and the second data over the time series. The data synchronization system may determine the smallest value of the one or more absolute values of the AUC difference. The data synchronization system may synchronize the first data and the second data by using the smallest absolute value of the AUC difference to shift at least one of the first data and the second data for the time series.

The data synchronization system may use the AUC difference of the first data and the second data to train a machine learning (ML) model. The ML model may use one or more ML algorithms to evaluate data and synchronize data sets that are associated with the same event relating to and consisting of one or more objects, subjects, and/or features. Synchronizing data sets, including, for example, the first data and the second data, that are associated with the same event relating to and consisting of one or more objects, subjects, and/or features for a period of time may increase the accuracy in the collection, analysis, determination, and recordation of data associated with events, objects, subjects, and/or features. The synchronized data sets may also be used to correct any time delays or lags between the local clocks of sensors, which may also increase the accuracy in the collection, analysis, determination, and recordation of data associated with events, objects, subjects, and/or features. Such accurate data with accurate time stamps may be used to accurately identify and detect particular events, objects, subjects, and/or features in an environment at the precise time and location that such events, objects, subjects, and/or features were identified and detected by an ego vehicle. Entities, such as, for example, the driver of the ego vehicle, law enforcement, security agency, mechanics, paramedics, emergency responders, tow trucks, news agency, etc., may be able to use the synchronized data to more efficiently and effectively relay and respond to the objects, subjects, and/or features identified and detected by the ego vehicle. The accurate data, along with the precise time and location of events, objects, subjects, and/or features, may be used to update a map of the environment where the updated map may be used to navigate a vehicle more efficiently through the environment. Many variations are possible.

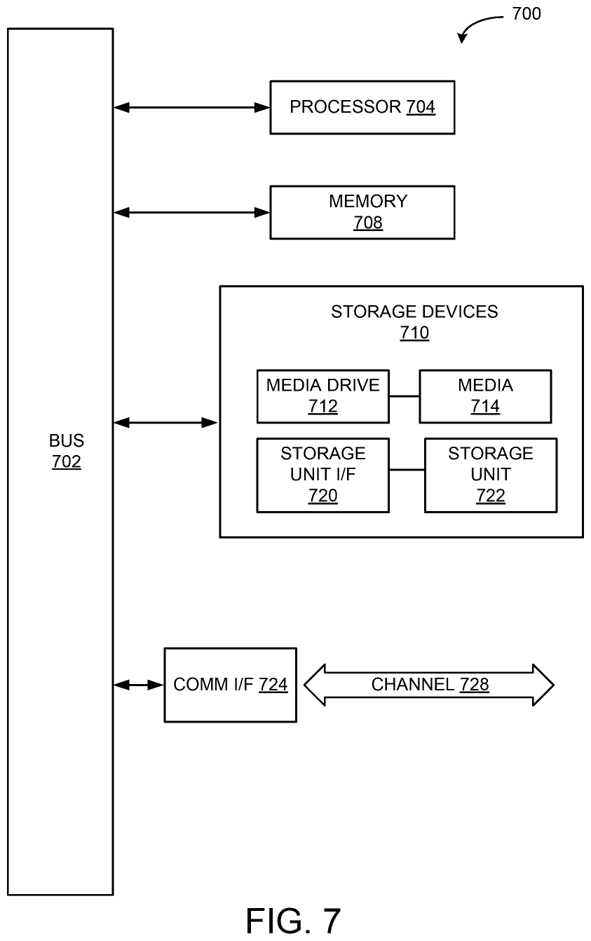

As used herein, the terms circuit and component might describe a given unit of functionality that can be performed in accordance with one or more embodiments of the present application. As used herein, a component might be implemented utilizing any form of hardware, software, or a combination thereof. For example, one or more processors, controllers, ASICs, PLAS, PALs, CPLDs, FPGAs, logical components, software routines or other mechanisms might be implemented to make up a component. Various components described herein may be implemented as discrete components or described functions and features can be shared in part or in total among one or more components. In other words, as would be apparent to one of ordinary skill in the art after reading this description, the various features and functionality described herein may be implemented in any given application. They can be implemented in one or more separate or shared components in various combinations and permutations. Although various features or functional elements may be individually described or claimed as separate components, it should be understood that these features/functionality can be shared among one or more common software and hardware elements. Such a description shall not require or imply that separate hardware or software components are used to implement such features or functionality.

Where components are implemented in whole or in part using software, these software elements can be implemented to operate with a computing or processing component capable of carrying out the functionality described with respect thereto. One such example computing component is shown in FIG. 7. Various embodiments are described in terms of this example-computing component 700. After reading this description, it will become apparent to a person skilled in the relevant art how to implement the application using other computing components or architectures.

Referring now to FIG. 7, computing component 700 may represent, for example, computing or processing capabilities found within a self-adjusting display, desktop, laptop, notebook, and tablet computers. They may be found in hand-held computing devices (tablets, PDA's, smart phones, cell phones, palmtops, etc.). They may be found in workstations or other devices with displays, servers, or any other type of special-purpose or general-purpose computing devices as may be desirable or appropriate for a given application or environment. Computing component 700 might also represent computing capabilities embedded within or otherwise available to a given device. For example, a computing component might be found in other electronic devices such as, for example, portable computing devices, and other electronic devices that might include some form of processing capability. In another example, a computing component might be found in components making up vehicle 150, vehicle 200, data synchronization circuit 310, decision and control circuit 303, computing system 100, computing system 210, ECU 225, etc.

Computing component 700 might include, for example, one or more processors, controllers, control components, or other processing devices. This can include a processor, and/or any one or more of the components making up vehicle 150 of FIG. 1, vehicle 200 of FIG. 2, computing system 210 of FIG. 2, data synchronization system 300 of FIG. 3, data synchronization system 400 of FIG. 4, and data synchronization system 500 of FIG. 5. Processor 704 might be implemented using a general-purpose or special-purpose processing engine such as, for example, a microprocessor, controller, or other control logic. The processor 704 might be specifically configured to execute one or more instructions for execution of logic of one or more circuits described herein, such as data synchronization circuit 310, decision and control circuit 303, and logic for control systems 240. Processor 704 may be configured to execute one or more instructions for performing one or more methods, such as the method described in FIG. 6.

Processor 704 may be connected to a bus 702. However, any communication medium can be used to facilitate interaction with other components of computing component 700 or to communicate externally. In applications, processor 704 may fetch, decode, and execute one or more instructions to control processes and operations for enabling vehicle servicing as described herein. For example, instructions can correspond to steps for performing one or more steps of the method described in FIG. 6.

Computing component 700 might also include one or more memory components, simply referred to herein as main memory 708. For example, random access memory (RAM) or other dynamic memory, might be used for storing information and instructions to be executed by processor 704. Such instructions may include one or more instructions for execution of one or more logical circuits described herein. Instructions can include instructions 208 of FIG. 2, and instructions 309 of FIG. 3 as described herein, for example. Main memory 708 might also be used for storing temporary variables or other intermediate information during execution of instructions to be fetched, decoded, and executed by processor 704. Computing component 700 might likewise include a read only memory (“ROM”) or other static storage device coupled to bus 702 for storing static information and instructions for processor 704.

The computing component 700 might also include one or more various forms of information storage mechanism 710, which might include, for example, a media drive 712 and a storage unit interface 720. The media drive 712 might include a drive or other mechanism to support fixed or removable storage media 714. For example, a hard disk drive, a solid-state drive, a magnetic tape drive, an optical drive, a compact disc (CD) or digital video disc (DVD) drive (R or RW), or other removable or fixed media drive might be provided. Storage media 714 might include, for example, a hard disk, an integrated circuit assembly, magnetic tape, cartridge, optical disk, a CD or DVD. Storage media 714 may be any other fixed or removable medium that is read by, written to or accessed by media drive 712. As these examples illustrate, the storage media 714 can include a computer usable storage medium having stored therein computer software or data.

In alternative embodiments, information storage mechanism 710 might include other similar instrumentalities for allowing computer programs or other instructions or data to be loaded into computing component 700. Such instrumentalities might include, for example, a fixed or removable storage unit 722 and an interface 720. Examples of such storage units 722 and interfaces 720 can include a program cartridge and cartridge interface, a removable memory (for example, a flash memory or other removable memory component) and memory slot. Other examples may include a PCMCIA slot and card, and other fixed or removable storage units 722 and interfaces 720 that allow software and data to be transferred from storage unit 722 to computing component 700.

Computing component 700 might also include a communications interface 724. Communications interface 724 might be used to allow software and data to be transferred between computing component 700 and external devices. Examples of communications interface 724 might include a modem or softmodem, a network interface (such as Ethernet, network interface card, IEEE 802.XX or other interface). Other examples include a communications port (such as for example, a USB port, IR port, RS232 port Bluetooth® interface, or other port), or other communications interface. Software/data transferred via communications interface 724 may be carried on signals, which can be electronic, electromagnetic (which includes optical) or other signals capable of being exchanged by a given communications interface 724. These signals might be provided to communications interface 724 via a channel 728. Channel 728 might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to transitory or non-transitory media. Such media may be, e.g., memory 708, storage unit 720, media 714, and channel 728. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing component 700 to perform features or functions of the present application as discussed herein.

As described herein, vehicles can be flying, partially submersible, submersible, boats, roadway, off-road, passenger, truck, trolley, train, drones, motorcycle, bicycle, or other vehicles. As used herein, vehicles can be any form of powered or unpowered transport. Obstructions can include one or more potholes, cracks, tire markings, faded road markings, debris, objects, occlusion, road reflection, floodings, icy surfaces, oil leaks, uneven pavement, erosions, raveling and other potentially hazardous conditions on the road. Although roads are references herein, it is understood that the present disclosure is not limited to roads or to 1d or 2d traffic patterns.

Aspects herein can be embodied in other forms without departing from the spirit or essential attributes thereof. Accordingly, reference should be made to the following claims, rather than to the foregoing specification, as indicating the scope hereof. While various applications of the disclosed technology have been described above, it should be understood that they have been presented by way of example only, and not of limitation. Likewise, the various diagrams may depict an example architectural or other configuration for the disclosed technology, which is done to aid in understanding the features and functionality that can be included in the disclosed technology. The disclosed technology is not restricted to the illustrated example architectures or configurations, but the desired features can be implemented using a variety of alternative architectures and configurations. Indeed, it will be apparent to one of skill in the art how alternative functional, logical or physical partitioning and configurations can be implemented to implement the desired features of the technology disclosed herein. Also, a multitude of different constituent module names other than those depicted herein can be applied to the various partitions. Additionally, with regard to flow diagrams, operational descriptions and method claims, the order in which the steps are presented herein shall not mandate that various applications be implemented to perform the recited functionality in the same order, and with each of the steps shown, unless the context dictates otherwise.

It should be understood that the various features, aspects and functionality described in one or more of the individual embodiments are not limited in their applicability to the particular embodiment with which they are described. Instead, they can be applied, alone or in various combinations, to one or more other embodiments, whether or not such embodiments are described and whether or not such features are presented as being a part of a described embodiment. Thus, the breadth and scope of the present application should not be limited by any of the above-described exemplary embodiments.

Terms and phrases used in this document, and variations thereof, unless otherwise expressly stated, should be construed as open ended as opposed to limiting. As examples of the foregoing, the term “including” should be read as meaning “including, without limitation” or the like. The term “example” is used to provide exemplary instances of the item in discussion, not an exhaustive or limiting list thereof. The term “operably connected,” “coupled”, or “coupled to”, as used throughout this description, can include direct or indirect connections, including connections without direct physical contact, electrical connections, optical connections, and so on. The terms “a” or “an” should be read as meaning “at least one,” “one or more” or the like; and adjectives such as “conventional,” “traditional,” “normal,” “standard,” “known.” Terms of similar meaning should not be construed as limiting the item described to a given time period or to an item available as of a given time. Instead, they should be read to encompass conventional, traditional, normal, or standard technologies that may be available or known now or at any time in the future. Where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “component” does not imply that the aspects or functionality described or claimed as part of the component are all configured in a common package. Indeed, any or all of the various aspects of a component, whether control logic or other components, can be combined in a single package or separately maintained and can further be distributed in multiple groupings or packages or across multiple locations.

It should be noted that the terms “accurate,” “accurately,” and the like as used herein can be used to mean making or achieving performance as effective or perfect as possible. However, as one of ordinary skill in the art reading this document will recognize, perfection cannot always be achieved. Accordingly, these terms can also encompass making or achieving performance as good or effective as possible or practical under the given circumstances, or making or achieving performance better than that which can be achieved with other settings or parameters.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A computer implemented method for synchronizing sensor data from a plurality of sensors of a vehicle, the method comprising:
receiving, from a first sensor, a first data relating to an event, wherein the first data comprises a first time stamp;
receiving, from a second sensor, a second data relating to the event, wherein the second data comprises a second time stamp;
determining the first time stamp is not identical to the second time stamp;
determining which of the first time stamp and the second time stamp is a correct time stamp for the event; and
synchronizing, based on the correct time stamp, the first data and the second data.

2. The method of claim 1, wherein the determining the first time stamp is not identical to the second time stamp comprises:
comparing the first time stamp to a first local clock of the first sensor;
comparing the second time stamp to a second local clock of the second sensor;
determining a time delay between at least the first time stamp and the first local clock or the second time stamp and the second local clock; and
determining the first time stamp is not identical to the second time stamp according to the time delay.

3. The method of claim 1, wherein the synchronizing, based on the correct time stamp, the first data and the second data comprises adjusting at least one of the first data and the second data according to the correct time stamp and an area under the curve (AUC) difference between the first data and the second data.

4. The method of claim 3, wherein the AUC difference comprises:
determining a first AUC of the first data;
determining a second AUC of the second data; and
determining the AUC difference between the first AUC and the second AUC.

5. The method of claim 1, wherein the first sensor is located at a first location on the vehicle and the second sensor is located at a second location on the vehicle.

6. The method of claim 1, wherein the first and second sensors each comprise at least one of a camera, image sensor, radar sensor, environmental sensor, light detection and ranging (LiDAR) sensor, electromyography sensor, motion sensor, pressure sensor, position sensor, audio sensor, infrared sensor, microwave sensor, optical sensor, haptic sensor, magnetometer, communication system and global positioning system (GPS).

7. The method of claim 1, wherein the first data and the second data each comprise at least one of environmental data and vehicular data.

8. The method of claim 7, wherein the environmental data comprises a road condition, traffic, location, coordinates, population, landscape, landmark, terrain, territory, weather, temperature, humidity, pollution, habitat, and other environmental surroundings.

9. The method of claim 7, wherein the vehicular data comprises a speed, acceleration, direction, handling, torque, trajectory, force, tire grip, traction, and steering of the vehicle.

10. The method of claim 1, wherein the correct time stamp is a time that the event is first detected by either the first sensor or the second sensor.

11. The method of claim 1, wherein the event is a detection of an element in an environment of the vehicle, and the method further comprises using the correct time stamp to determine a location of the detected element.

12. A computer system for synchronizing sensor data from a plurality of sensors of a vehicle, the system comprising:
one or more processors; and
memory coupled to the one or more processors to store instructions, which when executed by the one or more processors, cause the one or more processors to perform operations, the operations comprising:
receiving, from a first sensor, a first data relating to an event, wherein the first data comprises a first time stamp;
receiving, from a second sensor, a second data relating to the event, wherein the second data comprises a second time stamp;
determining the first time stamp is not identical to the second time stamp;
determining which of the first time stamp and the second time stamp is a correct time stamp for the event; and
synchronizing, based on the correct time stamp, the first data and the second data.

13. The system of claim 12, wherein the determining the first time stamp is not identical to the second time stamp comprises:
comparing the first time stamp to a first local clock of the first sensor;
comparing the second time stamp to a second local clock of the second sensor;
determining a time delay between at least the first time stamp and the first local clock or the second time stamp and the second local clock; and
determining the first time stamp is not identical to the second time stamp according to the time delay.

14. The system of claim 12, wherein the synchronizing, based on the correct time stamp, the first data and the second data comprises adjusting at least one of the first data and the second data according to the correct time stamp and an area under the curve (AUC) difference between the first data and the second data.

15. The system of claim 14, wherein the AUC difference comprises:
determining a first AUC of the first data;
determining a second AUC of the second data; and
determining the AUC difference between the first AUC and the second AUC.

16. The system of claim 12, wherein the first data and the second data each comprise at least one of environmental data and vehicular data.

17. The system of claim 16, wherein the environmental data comprises a road condition, traffic, location, coordinates, population, landscape, landmark, terrain, territory, weather, temperature, humidity, pollution, habitat, and other environmental surroundings.

18. The system of claim 16, wherein the vehicular data comprises a speed, acceleration, direction, handling, torque, trajectory, force, tire grip, traction, and steering of the vehicle.

19. A non-transitory machine-readable medium having instructions stored therein, which when executed by a processor, cause the processor to perform operations, the operations comprising:
receiving, from a first sensor, a first data relating to an event, wherein the first data comprises a first time stamp;
receiving, from a second sensor, a second data relating to the event, wherein the second data comprises a second time stamp;
determining the first time stamp is not identical to the second time stamp;
determining which of the first time stamp and the second time stamp is a correct time stamp for the event; and
synchronizing, based on the correct time stamp, the first data and the second data.

20. The non-transitory machine-readable medium of claim 19, wherein the synchronizing, based on the correct time stamp, the first data and the second data comprises:
determining a first area under the curve (AUC) of the first data;
determining a second AUC of the second data;
determining an AUC difference between the first AUC and the second AUC;
adjusting at least one of the first data and the second data according to the correct time stamp and the AUC difference.
